(19) United States
(12) Patent Application Publication
(10) Pub. No.: US 2014/0032336 A1
(43) Pub. Date: Jan. 30, 2014

(54) SYSTEM AND METHOD FOR ELECTRONIC COUPON MANAGEMENT

(71) Applicant: YAHOO JAPAN CORPORATION, Tokyo (JP)

(72) Inventor: Yasushi KOKUBO, Tokyo (JP)

(73) Assignee: YAHOO JAPAN CORPORATION, Tokyo (JP)

(21) Appl. No.: 13/737,447

(22) Filed: Jan. 9, 2013

(30) Foreign Application Priority Data
Jul. 25, 2012 (JP) 2012-165180

(51) Int. Cl. G06Q 30/02

(52) U.S. Cl. CPC G06Q 30/0277
USPC 705/14.73

(57) ABSTRACT

An electronic coupon management system includes a coupon server apparatus. The coupon server apparatus includes an interface unit, a commercial facility ID (Identification) retaining unit, a submission receiving unit, an electronic coupon generating unit, and an electronic coupon publicizing unit. The interface unit is publicized to an external terminal apparatus via a network. The commercial facility ID (Identification) retaining unit retains commercial facility IDs. The submission receiving unit receives submission of an electronic coupon via the interface unit along with selection of at least one commercial facility ID from the commercial facility IDs retained in the commercial facility ID retaining unit. The electronic coupon generating unit generates the submission-received electronic coupon in a lock state which is cancellable by the selected commercial facility. The electronic coupon publicizing unit publicizes the generated electronic coupon via the interface unit to make the electronic coupon available to a customer.

### CROSS-REFERENCE TO RELATED APPLICATION

The present application is based upon and claims the benefit of priority from Japanese Patent Application No. 2012-165190, filed on Jul. 25, 2012, the entire contents of which are incorporated herein by reference.

### BACKGROUND OF THE INVENTION

1. Field of the Invention

The present invention relates to an electronic coupon management.

2. Description of the Related Art

Various technologies for issuing coupons (special offer) are known as means for persuading customers to visit stores. One known special-offer issue proxy system receives requests to issue a special offer to distribute at specific stores other than the store of the requestor. Such special-offer issue proxy system issues a special offer to the customers of the specific stores whose customers are likely to be the customers of the store of the requestor, and thus is considered to be effective in attracting more customers to the store of the requestor. One example of such system is described in Japanese Laid-open Patent Publication No. 2010-182119.

However, in the conventional technologies, a store requested to issue the special offers merely issues coupons usable in other stores, and does not gain from the issuance of coupons. To make other stores involved in coupon issuance, e.g., as a proxy coupon issuer, it is preferable that reasonable incentives be offered to these stores.

### SUMMARY OF THE INVENTION

According to one aspect of the present invention, an electronic coupon management system includes a coupon server apparatus. The coupon server apparatus includes an interface unit that is publicized to an external terminal apparatus via a network, a commercial facility ID (Identification) retaining unit that retains commercial facility IDs, a submission receiving unit that receives submission of an electronic coupon via the interface unit along with selection of at least one commercial facility ID from the commercial facility IDs retained in the commercial facility ID retaining unit, an electronic coupon generating unit that generates the submission-received electronic coupon in a lock state which is cancellable by the selected commercial facility, and an electronic coupon publicizing unit that publicizes the electronic coupon generated by the electronic coupon generating unit via the interface unit to make the electronic coupon available to a customer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram illustrating an electronic coupon management system according to an embodiment of the present invention;

FIG. 2 is a diagram illustrating an example of an electronic coupon described by a language file according to an embodiment;

FIG. 3 is a flowchart illustrating an example of the flow of electronic coupon use according to an embodiment;

FIG. 4 is a diagram illustrating an example of a functional block of a coupon server apparatus according to a first embodiment;

FIG. 5 is a diagram illustrating an example of commercial facility IDs retained by a commercial facility ID retaining unit of the coupon server apparatus according to the first embodiment;

FIG. 6 is a diagram illustrating an example of a submission screen displayed op an external terminal apparatus to receive submission of an electronic coupon;

FIG. 7 is a diagram illustrating an example of a submission screen used to directly input the commercial facility ID of an electronic coupon issuing source and the commercial, facility ID of a commercial facility which is a lock cancellation destination of the electronic coupon;

FIG. 8 is a diagram illustrating an example of a process in an electronic coupon generating unit;

FIG. 9 is a diagram illustrating an example of a hardware configuration of the coupon server apparatus according to the first embodiment;

FIG. 10 is a diagram illustrating an example of the flow of a process of the coupon server apparatus according to the first embodiment;

FIG. 11 is a diagram illustrating an example of a functional block of a coupon server apparatus according to a second embodiment;

FIG. 12 is a diagram illustrating a submission screen which is an example of use of a commercial facility attribute using unit when an electronic coupon is submitted;

FIG. 13 is a diagram illustrating an example of the flow of a process in the coupon server apparatus according to the second embodiment;

FIG. 14 is a diagram illustrating an example of a functional block of a coupon server apparatus according to a third embodiment;

FIG. 15 is a diagram illustrating an example of a submission information search screen displayed on an external terminal by a submission circumstance publicizing unit;

FIG. 16 is a diagram illustrating another example in which commercial facilities examining submission of electronic coupons use submission information to analyze commercial facilities preferred as a lock cancellation destination;

FIG. 17 is a diagram illustrating an example of the flow of a process in the coupon server apparatus according to the third embodiment;

FIG. 18 is a diagram illustrating an example of a functional block of a coupon server apparatus according to a fourth embodiment;

FIG. 19 is a diagram illustrating an example of acquisition of acceptance information in a submission acceptance information acquiring unit;

FIG. 20 is a diagram illustrating an example of the flow of a process in the coupon server apparatus according to the fourth embodiment;

FIG. 21 is a diagram illustrating an example of a functional block of a coupon server apparatus according to a fifth embodiment;

FIG. 22 is a diagram illustrating an example of the flow of a process in the coupon server apparatus according to the fifth embodiment;

FIG. 23 is a diagram illustrating an example of a hardware configuration of a lock cancelling terminal apparatus according to a sixth embodiment; and

FIG. 24 is a diagram illustrating an example of the flow of a process in the lock cancelling terminal apparatus according to the sixth embodiment.

### DESCRIPTION OF EMBODIMENTS

Hereinafter, embodiments of the invention will be described with reference to the drawings. The invention is not limited to the embodiments, and may be modified in various forms within the scope which is not departing from the gist of the invention,

### First Embodiment

### Overview

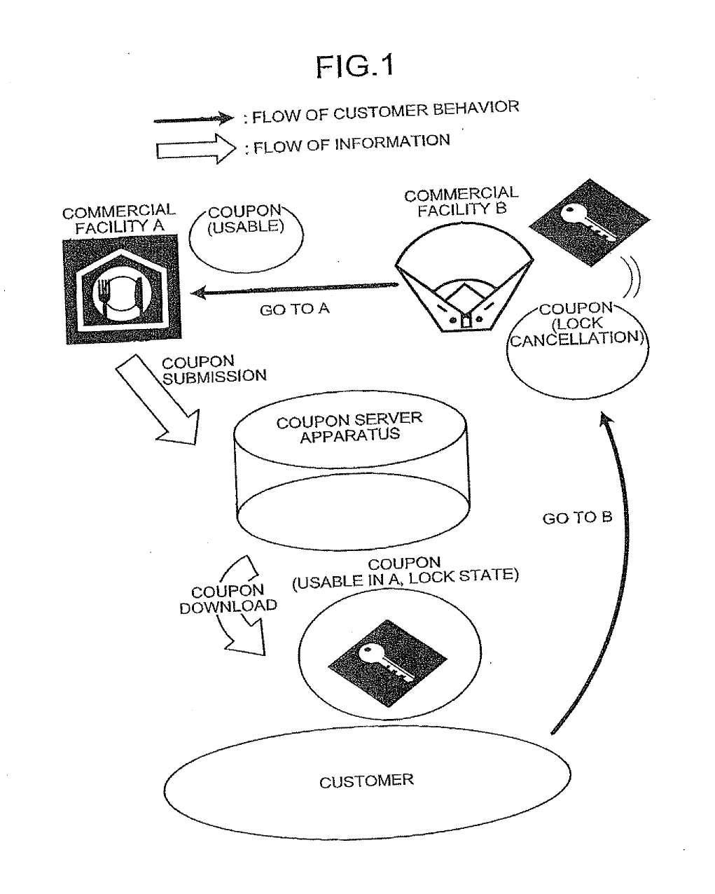

FIG. 1 is a schematic diagram illustrating an electronic coupon management system according to an embodiment of the present invention. As illustrated in FIG. 1, a coupon server apparatus according to the embodiment receives submission of an electronic coupon from an external terminal operated at commercial facility A. The coupon server apparatus generates an electronic coupon in accordance with the submitted contents and provides the electronic coupon to a user terminal. The electronic coupon is provided in a lock state in which the electronic coupon is unusable. The user terminal to which the electronic coupon is provided in the lock state performs a process of cancelling the lock state with an external apparatus operated at commercial facility B selected in advance as a lock cancellation destination. When the lock cancelling process is completed, the electronic coupon in the user terminal can be used in commercial facility A. In the electronic coupon management system, commercial facility A, which submits the electronic coupon, can utilize the issuance of electronic coupons as effective means for attracting customers by appropriately selecting a commercial facility as the lock cancellation destination. On the other hand, commercial facility B, which is designated as a facility to perform lock canceling process at the submission of the electronic coupon by the commercial facility A, can expect to attract customers by gaining a reputation as a facility where customers can make discount coupons usable. Here, the “commercial facilities” include any facilities where the users/customers pay the charge for their use; for example, a movie theater, an art gallery, a museum, a theater, a garden, a station, a parking place, a sports gymnasium, a zoo, an aquarium, a stadium, a concert ball, an amusement park, a pleasure place, a swimming beach, a camping area, a ski resort, and a fruit gathering farm in addition to a store. The scale of the facilities may be large or small.

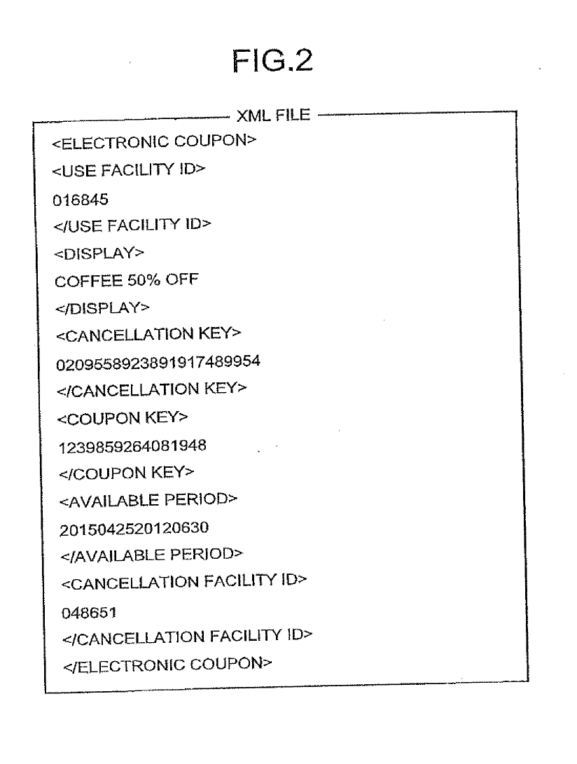

FIG. 2 depicts an example of an electronic coupon described as a language file according to an embodiment. As illustrated in FIG. 2, the electronic coupon includes information such as a commercial facility ID (Identification) of a commercial facility which is a submission source, information displayed as coupon contents, a cancellation key for cancelling the lock state, a coupon key used when the coupon is used, information indicating an available period, and a commercial facility ID of a commercial facility which is a lock cancellation destination. FIG. 2 illustrates data of the electronic coupon after whose lock state is cancelled at the commercial facility serving as the lock cancellation destination. Further details will be described later.

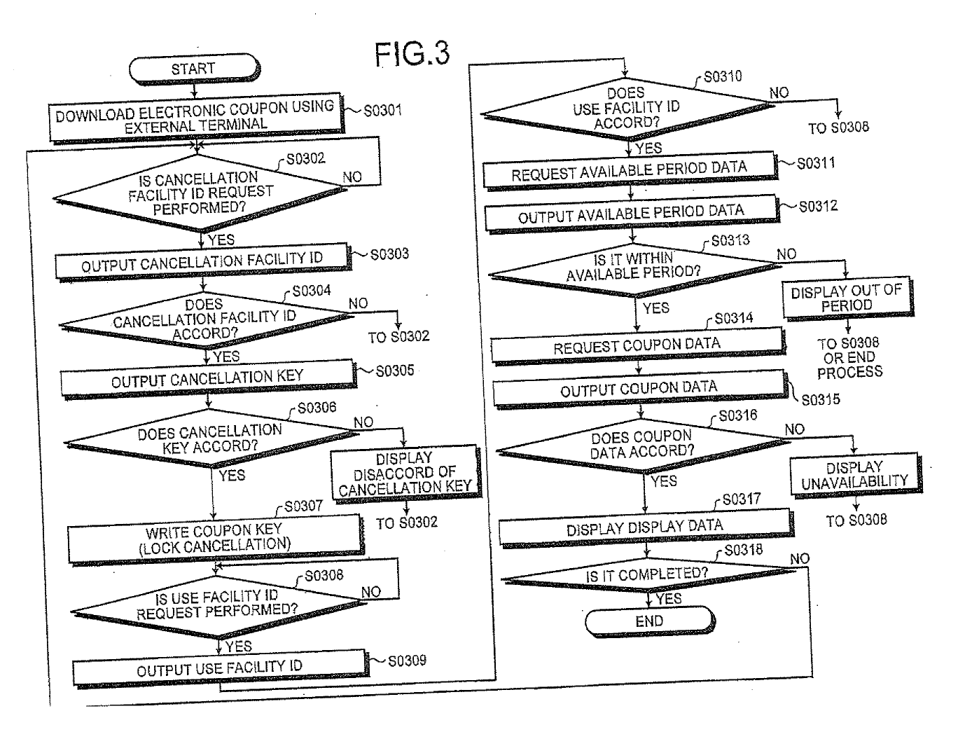

FIG. 3 is a flowchart illustrating an example of a process flow at the use of the electronic coupon illustrated in FIG. 2. As illustrated in FIG. 3, in step S0301, a customer downloads the data of an electronic coupon in a lock state from the coupon server apparatus using an external terminal apparatus such as a smart phone or a cellular phone. Next, in step S0302, the external terminal apparatus of the customer determines whether or not a terminal apparatus of the commercial facility, which is a lock cancellation destination, issues an output request for the commercial facility ID of the lock cancellation destination.

When the external terminal apparatus of the customer determines that there is an output request, the process proceeds to step S0303. Conversely, when the external terminal apparatus of the customer determines that there is no request, the process returns to step S0302. Next, in step S0303, the external terminal apparatus of the customer outputs the data of the commercial facility ID of the commercial facility which is the lock cancellation destination included in an electronic coupon file to the request source.

In step S0304, the terminal apparatus of the commercial facility which is the lock cancellation destination determines whether or not the commercial facility ID output from the terminal apparatus of the customer accords with a preset facility ID and sends back the result of determination to the terminal apparatus of the customer. When the terminal apparatus of the commercial facility determines that the commercial facility ID accords with the preset facility ID, the process proceeds to step S0305. Conversely, when the terminal apparatus of the commercial facility determines that the commercial facility ID does not accord with the preset facility ID, the process returns to step S0302. In step S0305, the terminal apparatus of the customer outputs the data of a cancellation key used to request cancellation of the lock state to the terminal apparatus of the commercial facility. Then, in step S0306, the terminal apparatus of the commercial facility determines whether or not the data of the cancellation key accords. When the terminal apparatus of the commercial facility determines that the data of the cancellation key accords, the process proceeds to step S0307. Conversely, when the terminal apparatus of the commercial facility determines that the data of the cancellation key does not accord, a message is displayed to indicate that the cancellation key does not accord. The message is displayed on the terminal apparatus of the commercial facility which is the lock cancellation destination or on the terminal apparatus of the customer, or on the both, and then the process returns to step S0302.

Next, in step S0307, a coupon key to be used to make the electronic coupon usable is written to the electronic coupon file. This process performed in the terminal apparatus of the customer is referred to as “lock cancellation.”

Next, in step S0308, the terminal apparatus of the customer determines whether or not the request for outputting the commercial facility ID of the commercial facility which is the coupon use destination is performed from the terminal apparatus used in the commercial facility which is the coupon use destination.

When the terminal apparatus of the customer determines that this request is performed, the process proceeds to step S0309. Conversely, when the terminal apparatus of the customer determines that no request is performed, the process returns to step S0308. In step S0309, the terminal apparatus of the customer outputs the data of the use facility ID included in the file of the electronic coupon to the request source. In step S0310, the terminal apparatus of the commercial facility determines whether or not the commercial facility ID output from the terminal apparatus of the customer accords with the preset facility ID. When the terminal apparatus of the commercial facility determines that the commercial facility ID accords with the preset facility ID, the process proceeds to step S0311. When the terminal apparatus of the commercial facility determines that the commercial facility ID does not accord with the preset facility ID, the process returns to step S0308. In step S0311, the terminal apparatus of the customer receives a request for an available period data from the terminal apparatus of the commercial facility. Then, in step S0312, the terminal apparatus of the customer outputs available period data included in the electronic coupon file to the terminal apparatus of the commercial facility. In step S0313, the terminal apparatus of the commercial facility determines whether or not the current date and time is within the available period indicated by the output available period data. When the current date and time is within the available period, the process proceeds to step S0314. When the current date and time is out of the available period and the available period has not come yet, the process returns to step S0308. When the current date and time is out of the available period and the available period has expired, the process ends.

In step S0314, the terminal apparatus of the customer receives the request for the coupon data from the terminal apparatus of the commercial facility. Then, in step S0315, the terminal apparatus of the customer outputs the coupon data to the terminal apparatus of the commercial facility. In step S0316, the terminal apparatus of the commercial facility determines whether or not the output coupon data accords with the originally available data. When the terminal apparatus of the commercial facility determines that the output coupon data accords with the originally available data, the process proceeds to step S0317. Conversely, when the terminal apparatus of the commercial facility determines that the output coupon data does not accord with the originally available data, a message indicating that the output coupon data is not available is displayed and the process returns to step S0308. In step S0317, display data in the coupon data is displayed on the terminal apparatus of the customer.

In step S0318, the terminal apparatus of the commercial facility determines whether or not to continue using the electronic coupon. When the terminal apparatus of the commercial facility determines to continue using the electronic coupon, the process returns to step S0302. Conversely, when the terminal apparatus of the commercial facility determines not to continue using the electronic coupon, the process ends.

Among the steps illustrated in FIG. 3, the process of step S0301 is performed by the external terminal apparatus of the customer. The processes of step S0302 to step S0307 are performed in the commercial facility which is the lock cancellation destination. The processes of step S0308 to step S031B are performed at the commercial facility which is the use destination of the electronic coupon.

A lock cancellation timing may be a timing at which a customer enters a commercial facility or a timing at which a customer purchases a product at the commercial facility or pays the cost of a provided service. A customer may ask an operator of the commercial facility for a password for cancelling the lock, and input the password by him/herself or ask the operator to input the password for cancelling the lock. In this case, the coupon server apparatus may transmit information regarding the password for cancelling the lock to the terminal apparatus of the operator of the commercial facility in advance. The coupon server apparatus may transmit a different password every time the electronic coupon is issued. Alternatively, the coupon server apparatus may issue and transmit information of a password specific to each commercial facility at the time the commercial facility registers its entry to the electronic coupon management system so that each commercial facility can use the password when designated as a lock cancellation destination (the lock cancellation will be described in detail in a sixth embodiment).

The functions of the coupon server apparatus and each terminal apparatus may be realized in any of hardware, software, or both hardware and software. Specifically, when a computer is used, the functions can be realized by a CPU, main memory, a bus, a secondary storage device (such as a hard disk, non-volatile memory, or a storage medium such as a CD or a DVD, a drive reading the medium), an input device used to input information, a printing apparatus or a display apparatus, a scanner apparatus, a hardware constituent unit such as other external peripheral devices, an interface for the external peripheral devices, a communication interface, a driver program or an application program for controlling the hardware, an application program for a user interface, or the like.

Data or the like input from an input device or another interface and retained on memory or a hard disk is processed or stored through arithmetic processing of a CPU in accordance with a program developed on main memory, or commands used to control each hardware or software are generated. The program may be realized as a plurality of modularized programs or two more programs may be combined and realized as one program.

This embodiment can be realized not only as an apparatus but also as a method. Further, some of the functions of the apparatus may be configured as software. Of course, a recording medium on which the software has been recorded is included in the technical scope of this embodiment (the same applies throughout the specification).

Functional Configuration

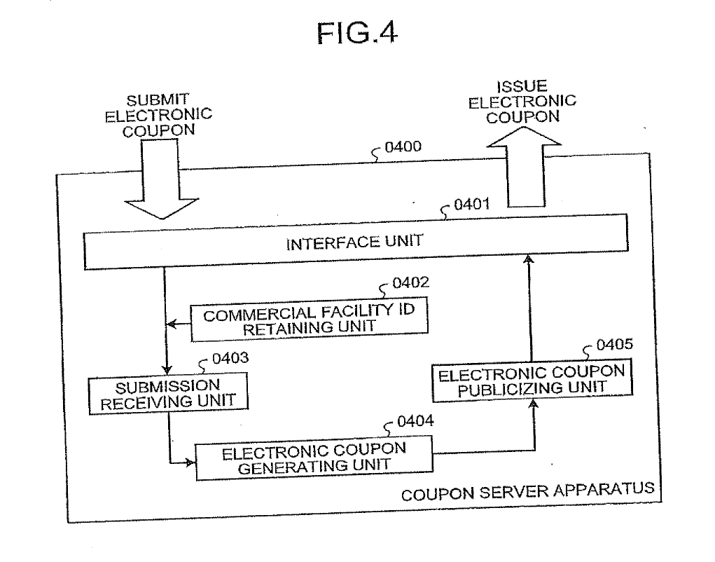

FIG. 4 is a diagram illustrating an example of a functional block of a coupon server apparatus in the electronic coupon management system according to the first embodiment. As illustrated in FIG. 4, a “coupon server apparatus” 0400 of the electronic coupon management system” according to the first embodiment includes an “interface unit” 0401, a “commercial facility ID retaining unit” 0402, a “submission receiving unit” 0403, an “electronic coupon generating unit” 0404, and an “electronic coupon publicizing unit” 0405.

The “interface unit” is publicized to an external terminal apparatus via the Internet, and thus has a function of intervening in transmission and reception of various kinds of information to and from an external terminal apparatus, such as input of submission information of an electronic coupon or publicizing of the electronic coupon, input and use of a commercial facility attribute, publicizing of a submission circumstance, and publicizing of an electronic coupon list.

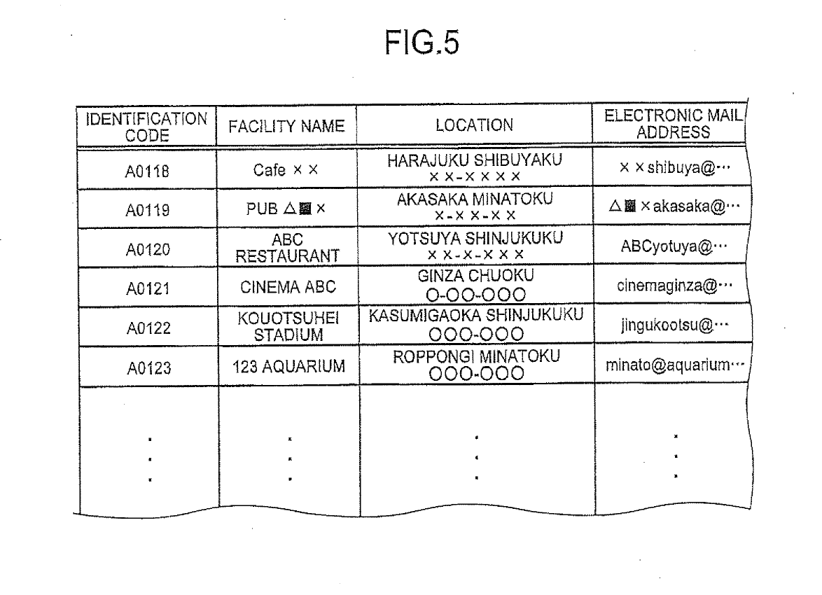

The “commercial facility ID retaining unit” has a function of retaining a commercial facility ID. The “commercial facility ID” is information used to identify and specify an individual commercial facility from other commercial facilities. For example, a specific identification number or identification code granted in advance, a name or a telephone number of a commercial facility, an electronic mail address, or the like can be considered. The commercial facility ID retaining unit may be configured to retain commercial facility IDs included in other service registration requests transmitted from terminals of commercial facilities. The commercial facility ID is selected at the coupon submission time to be described below. However, the operator of the commercial facility performing the submission is considered to select a commercial facility having the greatest advantage among their facilities at the submission time. Accordingly, to deal with the request of the operator of the commercial facility, the commercial facility ID retaining unit can be considered to retain the commercial facility ID such that an external terminal can search for the commercial facility ID. FIG. 5 is a diagram illustrating an example of the commercial facility IDs retained by the commercial facility ID retaining unit. In FIG. 5, a configuration of the commercial facility ID is exemplified in which an “identification code”, a “facility name”, a “location”, and an “electronic mail address” are retained as the commercial facility ID of one commercial facility. Keyword search is performed on such information. For example, when the keyword “Minato Ward” is used to search for a commercial facility in the same administrative district as the location of its commercial facility specified by the identification number “A0119,” the presence of the commercial facility which has the identification number “A0123” and in which the location is Minato Ward for the identification ID can be recognized.

With such a configuration, the operator of the commercial facility can easily examine whether to set a coupon to lock cancellation possibility at other commercial facilities at the coupon submission time. Further, the meaning of the “lock cancellation possibility” will be described in detail later.

The “submission receiving unit” has a function of receiving the submission of the electronic coupon along with selection of at least one commercial facility ID among the commercial facility IDs retained in the commercial facility ID retaining unit from the external terminal via the interface unit. The “submission receiving unit” may generate data of a submission screen having an input field used to input the contents of an electronic coupon in response to a request from an external terminal apparatus, transmit the generated data to the external terminal apparatus via the interface unit, and receive input on the submission screen. Here, the phrase, “selecting at least one commercial facility ID among the retained commercial facility IDs” specifically means selecting one or a plurality of commercial facility IDs among the retained commercial facility IDs. The range of the commercial facilities to be selected is not set in advance. A commercial facility which submits an electronic coupon may select itself as the lock cancellation destination. However, when the commercial facility which submits the electronic coupon selects itself as the lock cancellation destination, the advantage of issuing an electronic coupon in the lock state relatively decreases. Accordingly, a commercial facility other than the commercial facility which submits the electronic coupon is preferably selected as the lock cancellation destination.

As described above, the plurality of commercial facility IDs can be selected. The commercial facility ID is selected to specify a store at which the lock of the electronic coupon is cancelled. When the plurality of commercial facilities ID are selected and a coupon is submitted, the lack cancellation state is realized as long as a customer goes to one of the plurality of commercial facilities selected. Alternatively, the lock cancellation state is realized under the condition that a customer visits all the plurality of commercial facilities. In the configuration in which the lock is cancelled under the condition that a customer visits all the plurality of commercial facilities as in the latter, the customer goes round all the plurality of commercial facilities. In other words, the customer can feel the sense that the customer experiences an RPG game. Further, the customer can feel a sense of achievement, as if the customer clears a game. Since the customer 18 expected to visit each commercial facility lightheartedly, the number of customers attracted to each commercial facility is expected to increase in the configuration in which the plurality of commercial facility IDs can be selected.

Here, the phrase, “receiving the submission of the electronic coupon” means receiving from an external terminal apparatus, an input of coupon information including the contents of an electronic coupon an operator of a commercial facility, i.e., a coupon issuer, wishes to issue. The coupon information includes, for example, a name or an image of a product which is discounted by a coupon, a discount price, and a discount rate, such as “Beer 20% OFF” or “Adult Admission Ticket 500 yen Discount”. Further, the coupon information may include information other than discount, such as a product or service offered by the coupon. For example, the coupon information may be “A Dessert for Free”. That is, various kinds of information with the contents inducing customers to visit a store can be included in the coupon information.

The submission receiving unit may receive the submission in various manners. For example, the submission receiving unit may receive an input of a piece of information each corresponding to a specific item such as a discount rate and a name of a discounted product. Various types of special offers can be used in accordance with the characteristics of a commercial facility and issue timing, in view of a season, weather, special event, or the like. Hence, the submission receiving unit may receive an input of a free description (free comment), such as “A cup of Coffee is Free in Rainy Weather,” “Only first 100 Customers can Use Coupons,” “Valid Period Is Up To X Month X Day,” “Special Discount—New Product Launch Campaign,” made by the operator of the commercial facility. Further, the submission receiving unit may receive the inputs of both of the information of a specific item and the free comment.

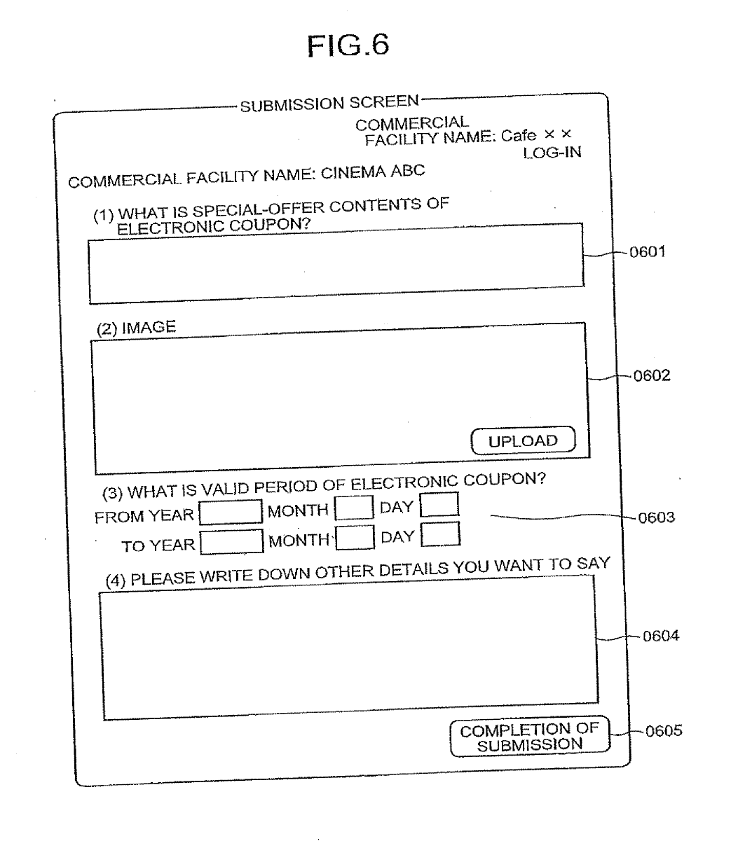

FIG. 6 is a diagram illustrating an example of a submission screen displayed on an external terminal apparatus to receive submission of an electronic coupon. FIG. 6 illustrates an example of a submission screen displayed when a commercial facility “Cafe XX” submits an electronic coupon to another commercial facility “Cinema ABC.”

In the example illustrated in FIG. 6, the coupon server apparatus first receives from an external terminal apparatus of a commercial facility (i.e., the commercial facility “Cafe XX”), which intends to submit a coupon, a commercial facility ID unique to the commercial facility “Cafe XX”. Then, the coupon server apparatus authenticates and permits the commercial facility “Cafe XX” to log in. The log-in state is indicated by the indication of “LOG-IN” at the upper right side of the submission screen in FIG. 6. Further, the coupon server apparatus receives a request for selecting commercial facility “cinema ABC” among the commercial facilities publicized by the interface unit of the coupon server apparatus, from the external terminal apparatus of commercial facility “Cafe XX”. Then, the coupon server apparatus displays the submission screen as illustrated in FIG. 6 on the external terminal apparatus of commercial facility “Cafe XX.”

The submission screen illustrated in FIG. 6 includes (1) a “special-offer content input field” 0601 used to input the special-offer content of the electronic coupon, (2) an “image posting field” 0602 used to post an image symbolizing the electronic coupon, (3) a “valid period input field” 0603 used to input the valid period of the electronic coupon, (4) a “message input field” 0604 used to input a message for a user of the electronic coupon, and (5) a “submission execution button” 0605 used to transmit the information input to the fields (1) to (4) to the coupon server apparatus to submit the electronic coupon. The terminal apparatus of commercial facility “Cafe XX” inputs information on the coupon submission screen of the web page and transmits the information to the coupon server apparatus via a network. The submission receiving unit of the coupon server apparatus receives the information input via the interface unit together with the commercial facility ID of the commercial facility which is the lock cancellation destination.

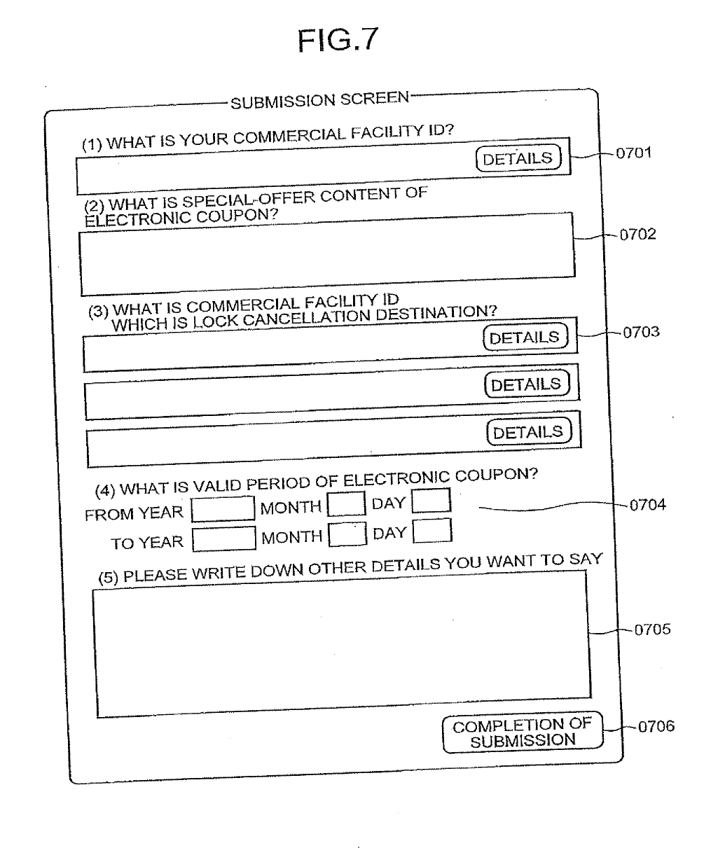

The submission of electronic coupon may be received directly by receiving an input of the commercial facility ID of a commercial facility which submits the electronic coupon, the commercial facility ID of the commercial facility which is the lock cancellation destination, or the like. FIG. 7 is a diagram illustrating an example of a submission screen used to directly input the commercial facility ID of an electronic coupon issuer and the commercial facility ID of the commercial facility which is the lock cancellation destination of the electronic coupon. The submission screen of FIG. 7 is configured such that the operator of the coupon-submitting commercial facility can designate, on one web page, more than one commercial facility as the lock cancellation destination.

The submission screen illustrated in FIG. 7 includes (1) an “issue source ID input field” 0701 used to input the commercial facility ID of the electronic coupon issuer, (2) a “special-offer content input field” 0702 used to input the special offer contents of the electronic coupon, (3) a “cancellation destination ID input field” 0703 used to input the commercial facility ID of the commercial facility which is the lock cancellation destination of the electronic coupon, (4) a “valid period input field” 0704 used to input the valid period of the electronic coupon, (4) a “message input field” 0705 used to input a message for a user of the electronic coupon, and (5) a “submission execution button” 0706 used to transmit the information input to the fields (1) to (4) to the coupon server apparatus to submit the electronic coupon.

The “electronic coupon generating unit” has a function of generating an electronic coupon of the submitted and received contents in a lock state which is cancellable at a selected commercial facility. The phrase “a lock state which is cancellable at a selected commercial facility” refers to a state in which the use of the electronic coupon is not accepted at the commercial facility set as a venue where the electronic coupon is usable, without the lock cancellation process at a designated commercial facility. The electronic coupon generating unit transmits the data of a cancellation key and a coupon key generated at the time of generating the electronic coupon to terminal apparatuses in commercial facilities which are lock cancellation destinations and in the commercial facilities which are coupon use destinations (to which the electronic coupon is submitted), and sets the cancellation key and the coupon key to correspond to the data of an electronic coupon file output from a portable terminal of a customer, when the customer goes to each commercial facility.

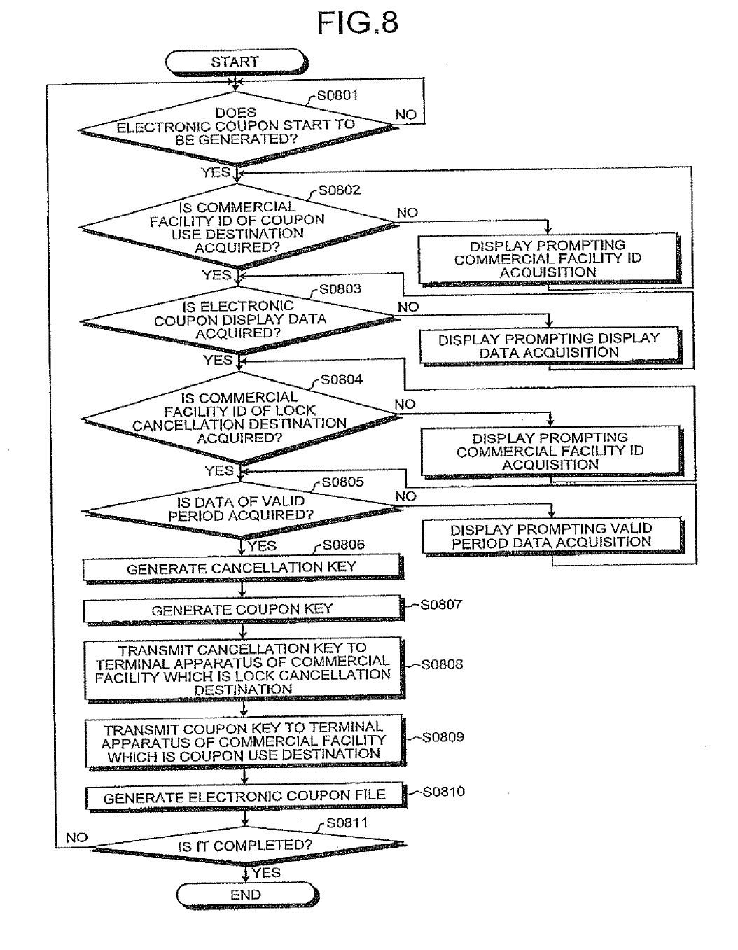

FIG. 8 is a diagram illustrating an example of a process in the electronic coupon generating unit of the coupon server apparatus according to the first embodiment. As illustrated in FIG. 8, in step S0801, it is determined whether an electronic coupon starts to be generated depending on whether the submission receiving unit receives the submission of the electronic coupon. When it is determined that the electronic coupon starts to be generated, the process proceeds to step S0802. Conversely, when it is determined that the electronic coupon does not start to be generated, the process returns to step S0801. Next, in step S0802, it is determined whether the commercial facility ID of the commercial facility which is the coupon use destination is acquired. When it is determined that the commercial facility ID of the commercial facility is acquired, the process proceeds to step S0803. When it is determined that the commercial facility ID of the commercial facility is not acquired, a process of displaying the contents prompting inputting the commercial facility ID in an external terminal apparatus of a submission source is performed via the interface unit, and then the process returns to step S0802. Next, in step S0803, it is determined whether data indicating the contents of the electronic coupon is acquired. When it is determined that the data is acquired, the process proceeds to step S0804. Conversely, when it is determined that the data is not acquired, a process of displaying the contents prompting inputting the contents of the electronic coupon on the external terminal apparatus of the submission source is performed via the interface unit, and then the process returns to step S0803. Then, in step S0804, it is determined whether the data of the commercial facility ID of the commercial facility which is the lock cancellation destination of the electronic coupon is acquired. When it is determined that the data of the commercial facility ID is acquired, the process proceeds to step S0805. Conversely, when it is determined that the data of the commercial facility ID is not acquired, a process of displaying the contents prompting inputting the commercial facility ID which is the lock cancellation destination in the external terminal apparatus of the submission source is performed via the interface unit, and then the process returns to step S0804. Next, in step S0805, it is determined whether the data of a valid period of the electronic coupon is acquired. When it is determined that the data of the valid period is acquired, the process proceeds to step S0806. Conversely, when it is determined that the data of the valid period is not acquired, a process of displaying the contents prompting inputting the data of the valid period in the external terminal apparatus of the submission source is performed, and then the process returns to step S0805. In step S0806, a cancellation key used to request the lock cancellation of the electronic coupon is generated. In step S0807, a coupon key used to set the electronic coupon to be available is generated. In step S0808, the data of the cancellation key is transmitted to a terminal apparatus in the commercial facility which is the lock cancellation destination. In step S0809, the data of the coupon key is transmitted to a terminal apparatus in the commercial facility which is the coupon use destination. In step S0810, an electronic coupon file is generated based on the acquired information. Among the acquired information, the data of the coupon key is not included in information regarding the electronic coupon file, when the electronic coupon is generated. In step S0811, it is determined whether the generation of the electronic coupon is completed. When it is determined that the generation of the electronic coupon is not completed, the process returns to step S0801. Conversely, when it is determined that the generation of the electronic coupon is completed, the process ends.

The order of the processes from step S0802 to step S0805 may differ. The order of the processes of step S0806 and step S0807 may be reversed, and the order of the processes of step S0808 and step S0809 may also be reversed.

The “electronic coupon publicizing unit” has a function of publicizing the electronic coupon generated by the electronic coupon generating unit to customers via the interface unit so that the customers can use the electronic coupon. For example, a web page presenting information of each commercial facility may be prepared, and the electronic coupon usable at the commercial facility may be presented in the web page in a downloadable manner. On the web page, the commercial facility which is the lock cancellation destination of the electronic coupon may be displayed in addition to the electronic coupon. Further, information of a commercial facility which designates itself as the lock cancellation destination may be displayed. When more than one commercial facility is a lock cancellation destination, information of these commercial facilities may be presented in a form of a list. In the list, the commercial facilities may be arranged in an order according to, for example, how fulfilling the contents of the coupon is, the number of visitors, timing of reception of the submission of coupon, and the valid period of the coupon. Each electronic coupon may continuously be publicized during the valid period or may automatically be stopped being publicized after a predetermined period expires. In such a configuration, only the electronic coupons of which the submission time is relatively recent are publicized. Therefore, the customers can obtain the latest information regarding the electronic coupons.

Whether to publicize the electronic coupons and the priority order of the publicizing methods may be determined in advance. Specifically, a method of obtaining an incentive to preferentially publicize the coupon contents in an auction way can be considered. A method of publicizing the coupon contents preferentially when a commercial facility of a high use ratio is mutually selected as the lock cancellation destination can be considered. Alternatively, a combination of these methods may be considered. In such a configuration, a specific commercial facility can be prevented from being selected excessively as the lock cancellation destination and suffered from overburden. Moreover, since the electronic coupons submitted from a highly relevant commercial facility are preferentially publicized, there is a high probability that a synergy effect in business can be expected.

A customer receives the information regarding the generated electronic coupon by accessing the web page using an external terminal. The electronic coupon management system according to the first embodiment is configured so that the lock state of the electronic coupon is cancelled when the customer goes to the selected and registered commercial facility. Therefore, the external terminal apparatus receiving the information regarding the electronic coupon is assumed to be a portable information terminal apparatus such as a smart phone, a portable telephone, or small notebook type PC easily carried up to the commercial facility which is the lock cancellation destination.

Specific Configuration of Coupon Sever Apparatus

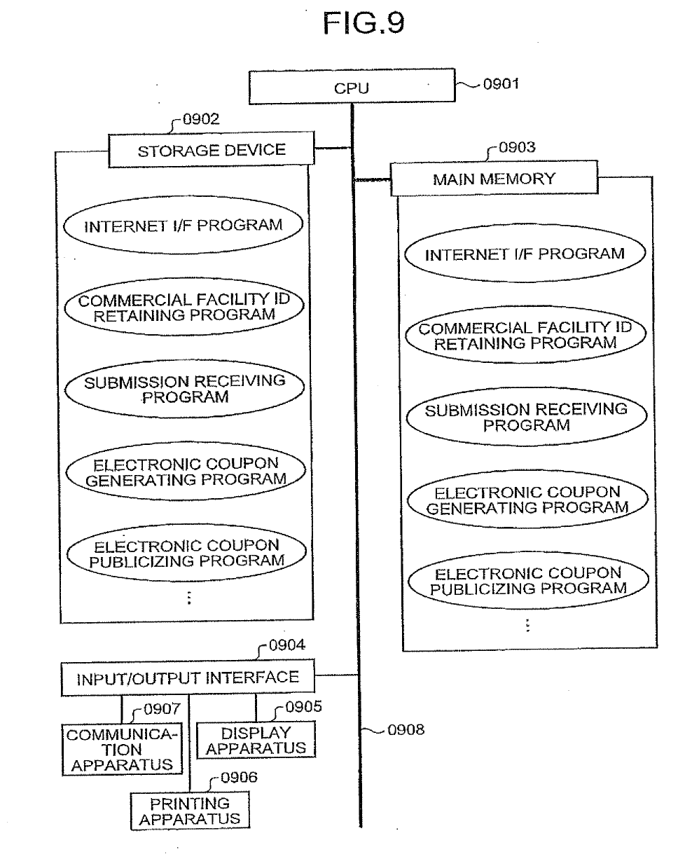

FIG. 9 is a schematic diagram illustrating an example of a hardware configuration when the functional constituent elements of the coupon server apparatus are realized by computer. The function of each hardware constituent element will be described with reference to FIG. 9.

As illustrated in FIG. 9, the coupon server apparatus includes a “CPU” 0901 that executes various arithmetic processes, a “storage device (storage medium)” 0902, a “main memory” 0903, and an “input/output interface” 0904. The coupon server apparatus transmits and receives information to and from a “display apparatus” 0905, a “printing apparatus” 0906, a “communication apparatus” 0907, and the like via the input/output interface, for example. The storage device stores various kinds of programs, and thus the CPU executes the various programs developed on the main memory. The above-described hardware constituent elements are connected to each other via a data communication path such as a “system bus” 0908 to perform processes or transmission and reception of information.

Specific Process of Interface Unit

The CPU executes an “Internet interface program” to perform a process of configuring an interface to publicize information to an external terminal via the Internet.

Specific Process of Commercial Facility ID Retaining Unit

The main memory stores and retains a plurality of commercial facilities ID in advance. The CPU executes a “commercial facility ID retaining program” to perform a process of reading the commercial facility ID selected by a user from a predetermined address of the main memory which is a storage destination when submission of the electronic coupon to be described below is received among the plurality of commercial facilities ID stored in advance in predetermined addresses of the main memory.

Specific Process of Submission Receiving Unit

The CPU executes a “submission receiving program” to perform a process of receiving not only information regarding the read specific commercial facility ID but also submission information of the electronic coupon via the Internet, and stores the result in a predetermined address of the main memory.

Specific Process of Electronic Coupon Generating Unit

The CPU executes an “electronic coupon generating program” to perform a process of generating a cancellation key and a coupon key enabling the lock state to be cancelled at the commercial facility relevant to the commercial facility ID selected by the user. Further, the CPU reads information obtained through the execution of the submission receiving program from the main memory, performs a process of generating an electronic coupon file in addition to the read information and information regarding the cancellation key obtained through this process, and stores the result in a predetermined address of the main memory. Furthermore, the CPU performs a process of transmitting the data of the cancellation key to the terminal apparatus of the commercial facility which is the lock cancellation destination and transmitting the data of the coupon key to the terminal apparatus of the commercial facility which is the coupon use destination.

Specific Process of Electronic Coupon Publicizing Unit

The CPU reads information obtained through the execution of the electronic coupon generating program, executes an “electronic coupon publicizing program,” performs a process of publicizing this information to the external terminals via the Internet.

Flow of Process

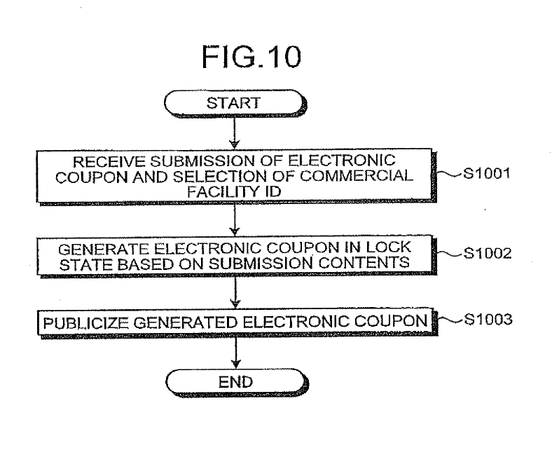

FIG. 10 is a diagram illustrating an example of the flow of the process to be performed by the coupon server apparatus according to the first embodiment. The flow of the process illustrated in FIG. 10 includes the following steps. First, in step S1001, the selection of the commercial facility ID and the submission of the electronic coupon from the external terminal are received. Next, in step S1002, the electronic coupon is generated in the lock state based on the submitted contents. Next, in step S1003, the generated electronic coupon is publicized to the external terminal.

Advantage

In the electronic coupon management system including the coupon server apparatus according to the first embodiment, the commercial facility designated and selected as the lock cancellation destination can expect a customer attracting effect of having a reputation among customers as a commercial facility at which electronic coupons can be made usable.

### Second Embodiment

### Overview

An electronic coupon management system according to a second embodiment is basically the same as the electronic coupon management system according to the first embodiment. However, the electronic coupon management system according to the second embodiment includes a commercial facility registration receiving unit that receives registration of a commercial facility to be specified with a commercial facility ID retained in a commercial facility ID retaining unit and a commercial facility attribute which is the attribute of the commercial facility; and a commercial facility ID recording unit that records the commercial facility ID of the commercial facility registered and received by the commercial facility registration receiving unit in association with the commercial facility attribute in the commercial facility ID retaining unit. The submission receiving unit includes a commercial facility attribute using unit that causes the recorded commercial facility attribute to be available via the interface when selecting the commercial facility ID. With such a configuration according to this embodiment, the information can be provided in accordance with the demand of various users for electronic coupons. For example, a user searches for a commercial facility popular as a lock cancellation destination or an operator of the electronic coupon management system introduces a method of using a plurality of electronic coupons in a specific place.

Functional Configuration.

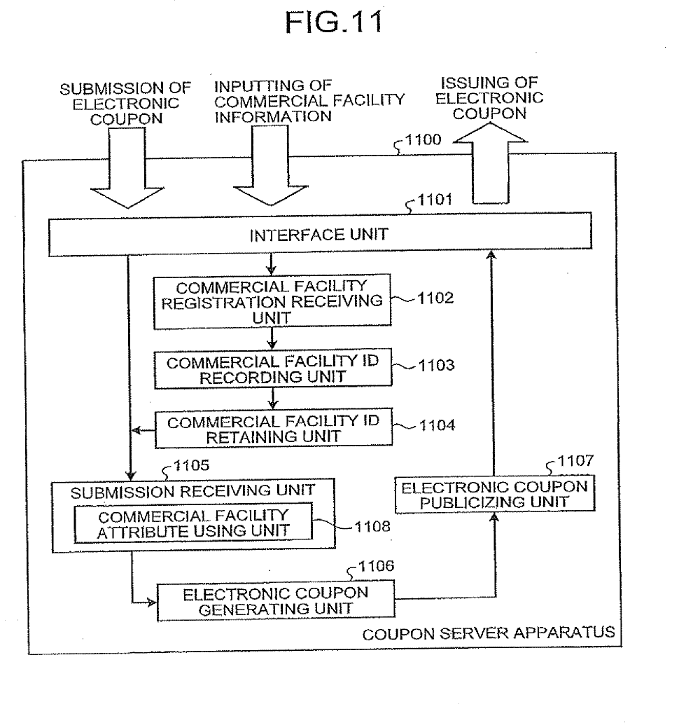

FIG. 11 is a diagram illustrating an example of a functional block of a coupon server apparatus in the electronic coupon management system according to the second embodiment. As illustrated in FIG. 11, a “coupon server apparatus” 1100 of the second embodiment includes an “interface unit” 1101, a “commercial facility registration receiving unit” 1102, a “commercial facility ID recording unit” 1103, a “commercial facility ID retaining unit” 1104, a “submission receiving unit” 1105, an “electronic coupon generating unit” 1106, and an “electronic coupon publicizing unit” 1107. The submission receiving unit includes a “commercial facility attribute using unit” 1108. The basic configuration of the coupon server apparatus is the same as the coupon server apparatus described with reference to FIG. 4 according to the first embodiment. Therefore, the “commercial facility registration receiving unit,” the “commercial facility ID recording unit,” and the “commercial facility attribute using unit” which are different constituent elements will be described below.

The “commercial facility registration receiving unit” has a function of receiving registration of a commercial facility to be specified with a commercial facility ID retained in the commercial facility ID retaining unit together with a commercial facility attribute which is the attribute of this commercial facility. The commercial facility ID is information used to distinguish the commercial facility from another commercial facility and specify the commercial facility, described above, and the “commercial facility attribute” is information used to characterize the commercial facility, although the commercial facility attribute itself does not sufficiently characterize the commercial facility. Examples of the commercial facility attribute include a business category or a product/service category, a brand category, a site location (for example, “adjacent to a large load” or “located at suburb”), a type of customer, the number of seats or a presence of a private room, a use purpose (for example, “business entertainment” or “banquet”), a shop holiday, an opening time, a crowded time or period, an average use fee of users, whether staff can use foreign languages, and whether there is a parking lot, and the number of cars which can be parked.

As a specific method of inputting the commercial facility attribute from an external terminal of a commercial facility, a method of receiving input of attribute items determined in advance may be used. A method of receiving input freely may be used. A combination of both the methods may be used.

The “commercial facility ID recording unit” has a function of recording the commercial facility ID of the commercial facility registered and received by the commercial facility registration receiving unit in association with the commercial facility attribute in the commercial facility ID retaining unit. The phrase “in association with the commercial facility attribute” means that the commercial facility ID and the commercial facility attribute of the commercial facility corresponding to the commercial facility ID are associated with each other and are stored in the commercial facility ID retaining unit. Due to the presence of the commercial facility ID recording unit having such a function, a user of the electronic coupon management system including the operator of the commercial facility can specify the commercial facility with the commercial facility ID associated with the attribute using the commercial facility attribute such as “neighboring movie theater,” “a coffee shop of which customers are mainly couples,” or “beauty shops opened even in Tuesday” (a specific specifying method or the like will be described in detail below).

The “commercial facility attribute using unit” has a function of causing an external terminal to use the recorded commercial facility attribute via the interface unit, when the commercial facility ID is selected in the submission receiving unit. The phrase, “causing an external terminal to use the commercial facility attribute via the interface unit” specifically means that the commercial facility attributes are processed as a database and all or some of the information in the database are publicized to the external terminal so that a user can use the commercial facility attributes, for example, by searching for the commercial facility attributes.

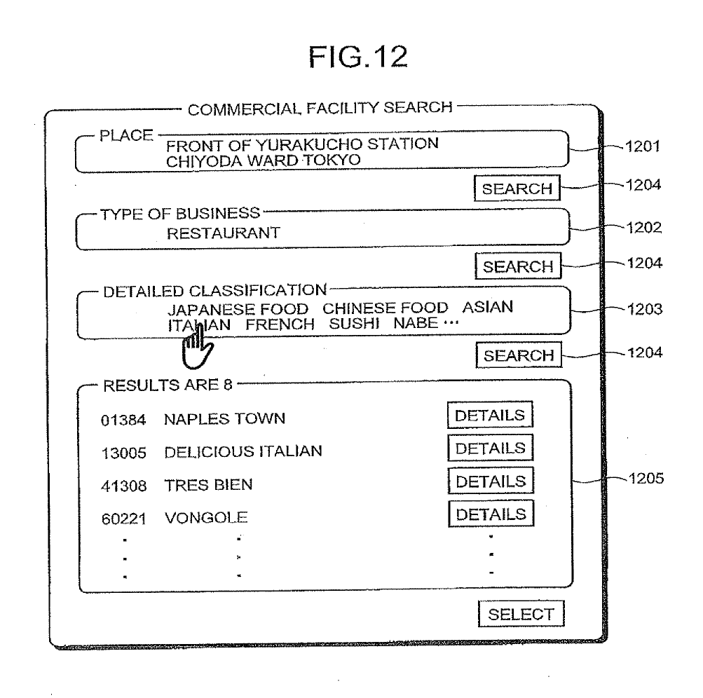

Here, as specific use forms of the database, various use forms can be considered depending on the purpose of the user. For example, in a case of a commercial facility performing submission, it can be considered that the database can be used to search for a commercial facility with the commercial facility attribute considered to be suitable as the lock cancellation destination. FIG. 12 is a diagram illustrating a commercial facility search screen as an example of the use form of the commercial facility attribute by the commercial facility attribute using unit according to the second embodiment. Here, the commercial facility search screen as exemplified in FIG. 12 is displayed before the user inputs submission information regarding the electronic coupon on the submission screen illustrated in FIG. 6. The commercial facility search screen is used to select a commercial facility which is the lock cancellation destination of a coupon. The search screen illustrated in FIG. 12 includes a “place name input field” 1201 used to input a place as a search condition, a “business type and business category input field” 1202 used to input a type of business as a search condition, a “business type classification input field” 1203 used to input detailed classification of type of business as a search condition, a “search start button” 1204 used to instruct the coupon server apparatus to search for a commercial facility using the information input in each field as the search conditions, and a “search result display field” 1205 used to display the search result.

The user can view and select a commercial facility suitable for the required conditions by inputting a specific place or a type of business or selecting a specific commercial facility attribute from the plurality of displayed commercial facility attributes. In FIG. 12, commercial facilities with the commercial facility attribute “Italian” among “restaurants” near “Yurakucho Station Chiyoda Ward Tokyo” are searched and eight commercial facilities are listed as the search result. Therefore, the user can select the commercial facility which is the lock cancellation destination confirming the list of the commercial facilities. When the user is a customer, the database can be used to search for a commercial facility in a place of a given range in which the customer goes to playing. As the searching method, a method can be considered in which the commercial facility attribute corresponding to any character information input by the user is extracted from the database and the search result is displayed and publicized in the alphabetical order. Further, a method can be considered in which a list of commercial facilities corresponding to each commercial facility attribute is displayed and publicized sequentially such that the commercial facility attribute with a high number of accesses and a high number of designations of the lock cancellation destination is displayed. In FIG. 11, a method of displaying the search results sequentially in an ascending order of the commercial facility IDs is illustrated.

For example, when the list of the commercial facilities having a specific commercial facility attribute (for example, “Japanese Food” or “near ΔΔ Station”) is displayed as the search results, a method can be considered in which the number of other commercial facilities selecting the commercial facilities as the lock cancellation destination and issuing the electronic coupons is displayed. Alternatively, a method can be considered in which when the number of other commercial facilities is plural, a commercial facility submitting an electronic coupon with the highest discount ratio or a commercial facility with the highest reputation for satisfaction of customers is preferentially displayed among the other commercial facilities. Information which is used when the user determines the use of the electronic coupon can be provided. For example, popularity of each commercial facility, high attraction of customers, or the like can be analyzed by displaying the information after reconstruction using the commercial facility attribute using unit.

It can be considered that the commercial facility attribute using unit is configured to publicize suggestion information obtained by using information regarding special-offer contents of an electronic coupon available in a commercial facility within a given place by use of the special-offer contents and the commercial facility attribute. Here, the “suggestion information” is considered to be information used to analyze a coupon submission situation of each commercial, facility in a given place and to suggest a walk course around the commercial facility in the order in which the electronic coupon having the contents of the relatively high discount rate is used or to suggest a date course including special-offer contents to couples only for a holiday. Further, a method can be considered in which the use histories of the electronic coupons is computed and the electronic coupons used many times by each user are issued, in other words, a course around a popular commercial facility is suggested. With such a configuration, the special-offer contents of the electronic coupons can actively appeal to customers without intentional search of the customers from information such as the commercial facility attribute as an electronic coupon provision form. Therefore, a customer induction effect can be improved due to the provision of the electronic coupons.

Specific Configuration of Coupon Server Apparatus

The hardware configuration of the coupon, server apparatus of the electronic coupon management system according to the second embodiment is basically the same as the hardware configuration of the coupon server apparatus described with reference to FIG. 9 according to the first embodiment. Therefore, specific processes of the commercial facility registration receiving unit, the commercial facility ID recording unit, and the commercial facility attribute using unit not described in the first embodiment will be described below.

Specific Process of Commercial Facility Registration Receiving Unit

The CPU executes a “commercial facility registration receiving program” to perform a process of receiving registration information of the commercial facility including the information regarding the commercial facility attribute and stores the received information in a predetermined address of the main memory.

Specific Process of Commercial Facility ID Recording Unit

The CPU executes a “commercial facility ID recording program” to perform a process of associating the information regarding the commercial facility attribute obtained through the execution of the commercial facility registration receiving program with the information regarding the commercial facility ID obtained through the execution of the commercial facility ID retaining program and stores the processed result in a predetermined address of the main memory.

Specific Process of Commercial Facility Attribute Using unit

The CPU executes a “commercial facility attribute using program” to perform a process of processing the information regarding the retained commercial facility attributes as a database and stores the result in a predetermined address of the main memory. Further, the CPU performs a process of extracting the commercial facility ID associated with the commercial facility attribute corresponding to the database in response to an instruction from the user or the operator of the electronic coupon management system and publicizing and outputting the result.

Flow of Process

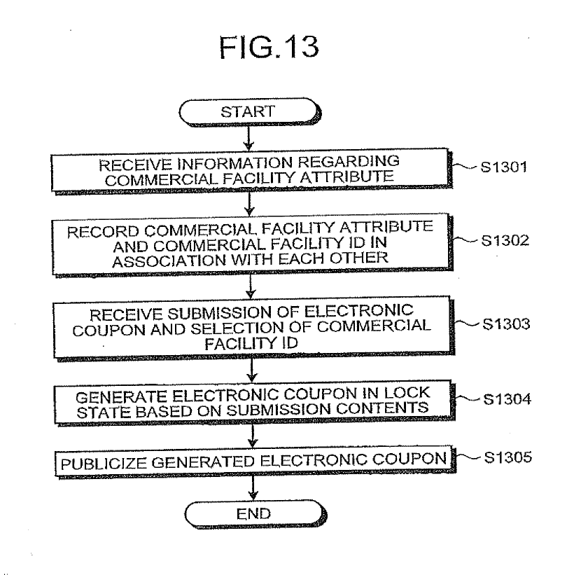

FIG. 13 is a diagram illustrating an example of the flow of a process performed by the coupon server apparatus of the electronic coupon management system according to this embodiment. The flow of the process illustrated in FIG. 13 includes the following steps. First, in step S1301, the information regarding the commercial facility attribute is received. Next, in step S1302, the information regarding the commercial facility attribute and the commercial facility ID are recorded in association with each other. Next, in step S1303, the selection of the commercial facility ID and the submission of the electronic coupon are received via the interface unit. Next, in step S1304, according to the submitted contents, an electronic coupon is generated in the lock state. Next, in step S1305, the generated electronic coupon is publicized via the interface unit.

Advantage

In the electronic coupon management system including the coupon server apparatus according to this embodiment, the information regarding the electronic coupon can be provided in accordance with the demand of various users in addition to the advantage of the first embodiment.

### Third Embodiment

### Overview

An electronic coupon management system according to this embodiment is basically the same as the electronic coupon management system according to the first embodiment. However, in this electronic coupon management system, the received submission information is recorded and the recorded submission information is publicized via the interface unit. In the configuration according to this embodiment, information regarding all of the coupon submission circumstance can be provided. For example, a commercial facility which is the lock cancellation destination can analyze a commercial facility selected as the lock cancellation destination among other commercial facilities, a tendency of the coupon submission destination of the commercial facility of the same business category, a market price of the coupon discount ratio, or the like by publicizing a discount ratio or the like set in the submitted coupon.

Functional Configuration

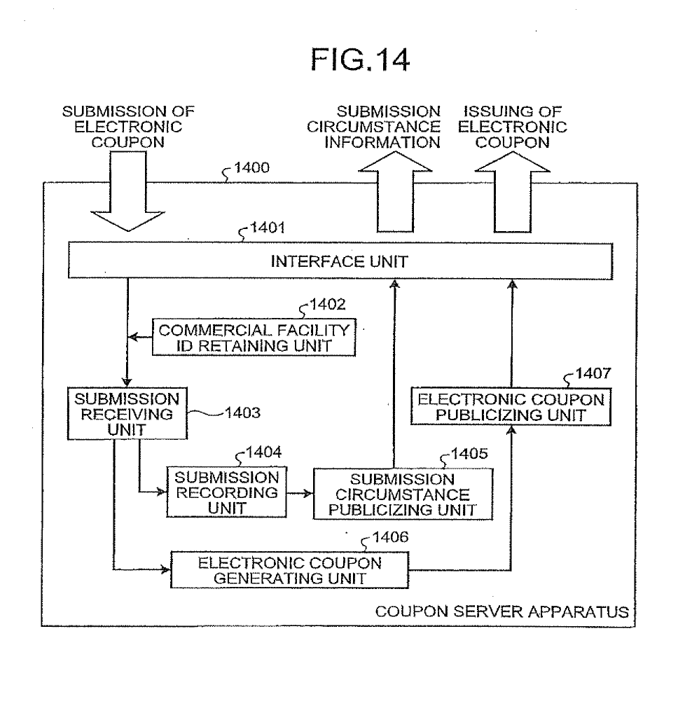

FIG. 14 is a diagram illustrating an example of the functional block of the coupon server apparatus of the electronic coupon management system according to this embodiment. As illustrated in the drawing, a “coupon server apparatus” 1400 according to this embodiment includes an “interface unit” 1401, a “commercial facility ID retaining unit” 1402, a “submission receiving unit” 1403, a “submission recording unit” 1404, a “submission circumstance publicizing unit” 1405, an “electronic coupon, generating unit” 1406, and an “electronic coupon publicizing unit” 1407. The basic configuration of the coupon server apparatus is the same as that of the coupon, server apparatus described with reference to FIG. 4 in the first embodiment. Therefore, the “submission recording unit” and the “submission circumstance publicizing unit” which are different constituent element will be described below.

The “submission recording unit” has a function of recording information regarding the submission received by the submission receiving unit in memory. The phrase, “recording the information regarding the submission received by the submission receiving unit” represents that various kinds of information associated with the fact of the submission or the submission are recorded. Specifically, examples of the information regarding the submission include not only the commercial facility ID of a commercial facility submitting the electronic coupon, the commercial facility attribute, and the contents of the special offer of the electronic coupon, but also the submission reception time and information of the actual achievement of the coupon issue which is information regarding all or some of the electronic coupons issued up to the present by the commercial facility.

The “submission circumstance publicizing unit” has a function of publicizing the information regarding the submission recorded in the submission recording unit to an external terminal via the interface unit. In the configuration in which the information regarding the submission is publicized, the user can analyze the fact that the commercial facility selected as the lock cancellation destination is selected among other commercial facilities and the business category or the like suitable for the commercial facility which is the lock cancellation destination.

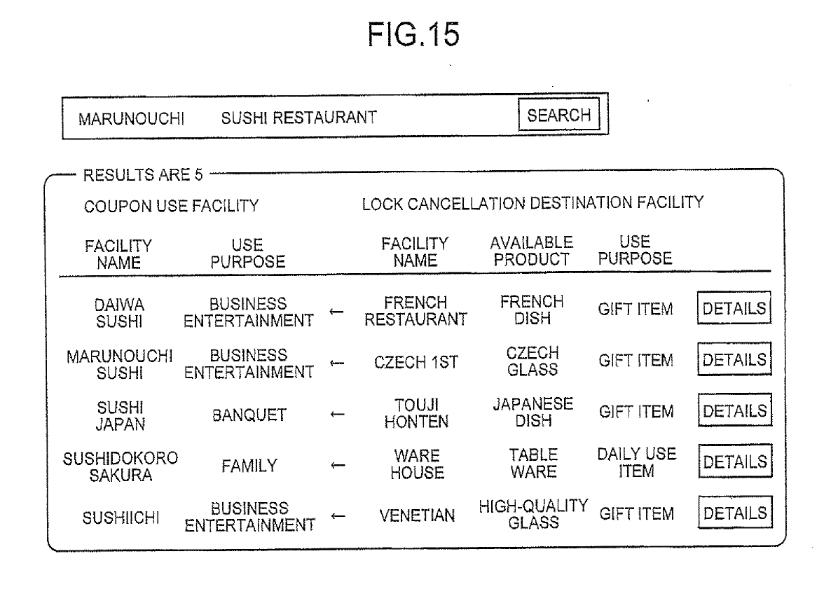

FIG. 15 is a diagram illustrating an example of a submission information search screen displayed on the external terminal by the submission circumstance publicizing unit. In FIG. 15, a case is exemplified in which a sushi restaurant at Marunouchi examines submission of an electronic coupon. First, when input of search words “Marunouchi” and “Sushi” is received from a terminal apparatus in the sushi restaurant, the submission circumstance publicizing unit displays the list of the submission circumstances of electronic coupons in commercial facilities associated with the commercial facility attributes “Marunouchi” and “Sushi.” In FIG. 15, five commercial facilities are listed as the search results from the name “Daiwa Sushi”. In the drawing, these commercial facilities are mainly used for “business entertainment” in the Marunouchi district which is an office street. Further, the commercial facilities in which Japanese and Western tableware is handled as gift items are selected as the lock cancellation destination. From the results, for example, an analysis can be established in which “business entertainment guests in sushi restaurants in the office street are mainly foreigners and the customers of the sushi restaurants purchase the Japanese and Western tableware as gift items in advance for the business entertainment of foreigners.” Therefore, taking such an analysis into consideration, the sushi restaurants examining the submission can lay out a strategy of selecting the commercial facilities, which handle the traditional. Japanese tableware which foreigners like as the gift items, as the lock cancellation destination.

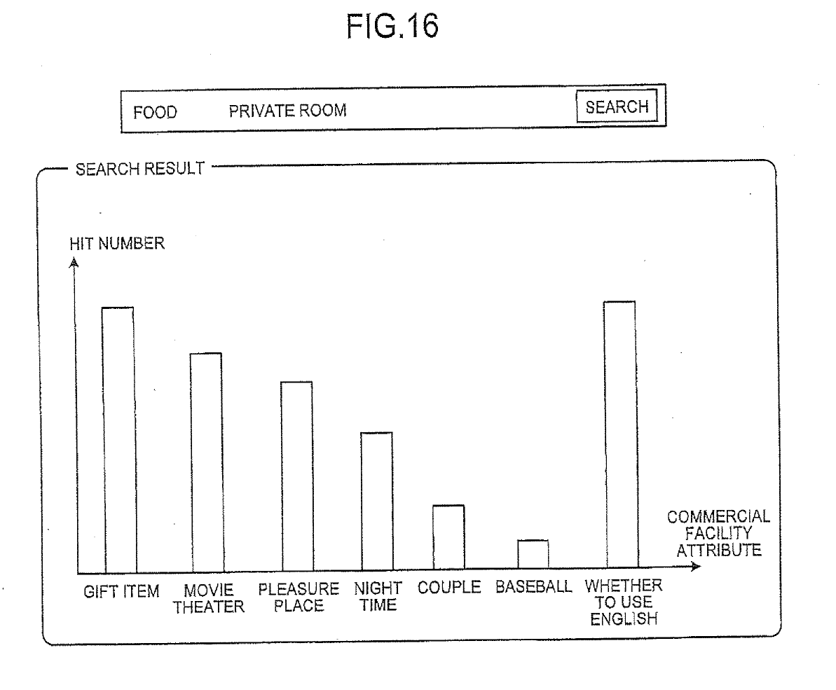

FIG. 16 is a diagram illustrating another example in which commercial facilities examining the submission of the electronic coupons use submission information to analyze commercial facilities preferred as the lock cancellation destination. In the drawing, a case is exemplified in which a restaurant having a private room examines the submission of the electronic coupons.

First, when input of the commercial facility attributes “food” and “private room” is received from a terminal apparatus in the restaurant, the submission circumstance publicizing unit displays a list of the commercial facility attributes associated with the commercial facilities selected at the submission time as the lock cancellation destination of the coupons by the commercial facilities having the commercial facility attributes in a bar graph in the descending order of hit number thereof. In the drawing, the commercial facilities including the attributes “private room” and “food” selects the commercial facilities associated with the commercial facility attributes such as “gift item”, “movie”, “pleasure place”, and “night time” as the lock cancellation destination. From the result, an analysis can be established in which “a considerable number of restaurants appealing with the private rooms submit the electronic coupons to induce customers who purchase gift items at other stores or go movie theaters or pleasure places to visit the own restaurants.” Therefore, taking such an analysis into consideration, the restaurants examining the submission can lay out a strategy of selecting commercial facilities such as movie theaters or department stores near the own restaurants as the lock cancellation destination.

As described with reference to the drawings, by enabling the information regarding all of the coupon submission circumstances to be publicized to external terminals, the commercial facilities examining the submission of the electronic coupons can analyze the commercial facilities to be selected as the lock cancellation destination or the display contents or the like of the electronic coupons designed to improve the customer attracting effect in detail and use the analysis as planning references of management strategies.

As a method of publicizing the submission information, a method of focusing on the contents of the electronic coupons can be considered. Specifically, for example, a method can be considered in which discount ratios are focused as the contents of the electronic coupons and the list of the electronic coupons is displayed preferentially from the electronic coupon of a higher discount ratio. In the configuration, it is possible to improve the advantages of the customers as the result obtained by issuing the electronic coupons competed to provide more attractive offers between the plurality of commercial facilities desiring to publicize preferential display.

Specific Configuration of Coupon Server Apparatus

The hardware configuration of the coupon server apparatus according to this embodiment is basically the same as the hardware configuration of the coupon server apparatus described with reference to FIG. 9 according to the first embodiment. Therefore, specific processes of the submission recording unit and the submission circumstance publicizing unit not described in the first embodiment will be described below.

Specific Process of Submission Recording Unit

The CPU reads the information obtained through the submission receiving program and executes a “submission recording program” to perform a process of storing information associated with the fact of the submission or the submission in a predetermined address of the main memory.

Specific Process of Submission Circumstance Publicizing Unit

The CPU executes a “submission circumstance publicizing program” to perform a process of publicizing the information obtained through the submission recording program via the interface.

Flow of Process

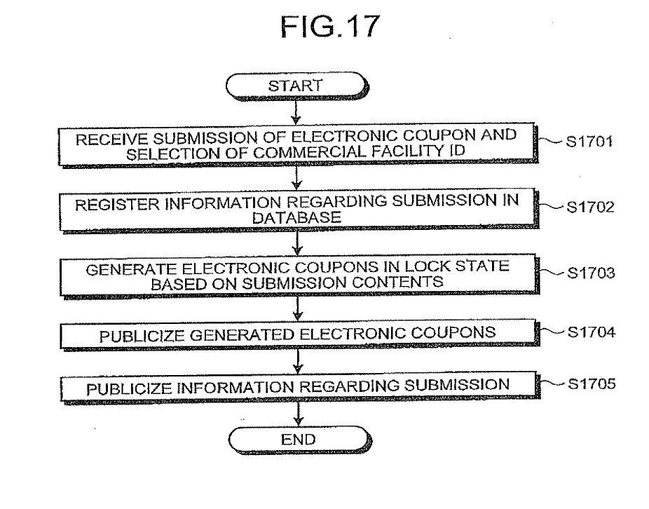

FIG. 17 is a diagram illustrating an example of the flow of a process performed by the coupon server apparatus according to this embodiment. The flow of the process in FIG. 17 includes the following steps. First, in step S1701, the selection of the commercial facility IDs and the submission of the electronic coupons are received via the interface. Next, in step S1702, the information regarding the submission is recorded in the database. Next, in step S1703, the electronic coupons are generated in the lock state based on the contents. Next, in step S1704, the generated electronic coupons are publicized via the interface. In step S1705, the information regarding the submission such as a submission time is publicized via the interface.

Advantage

In the electronic coupon management system including the coupon server apparatus according to this embodiment, the information regarding all of the coupon submission circumstances can be provided in addition to the advantage of the first embodiment. For example, a commercial facility which is the lock cancellation destination can analyze a commercial facility selected as the lock cancellation destination among other commercial facilities, a tendency of the coupon submission destination of the commercial facility of the same business category, a market price of the coupon discount ratio, or the like by publicizing a discount ratio or the like set in the submitted coupon.

### Fourth Embodiment

### Overview

An electronic coupon management system according to this embodiment is basically the same as the electronic coupon management system according to the first embodiment. However, in this electronic coupon management system, the submission of an electronic coupon is received only when submission acceptance information which is information indicating acceptance of the submission is obtained from a commercial facility selected as a submission destination. In the configuration according to this embodiment, the commercial facility selected as the submission destination can avoid becoming lock cancellation destination of the electronic coupon submitted by another commercial facility considered not to be preferable. Therefore, the commercial facility itself can construct a corporation relation with other commercial facilities considered to be advantageous.

Functional Configuration.

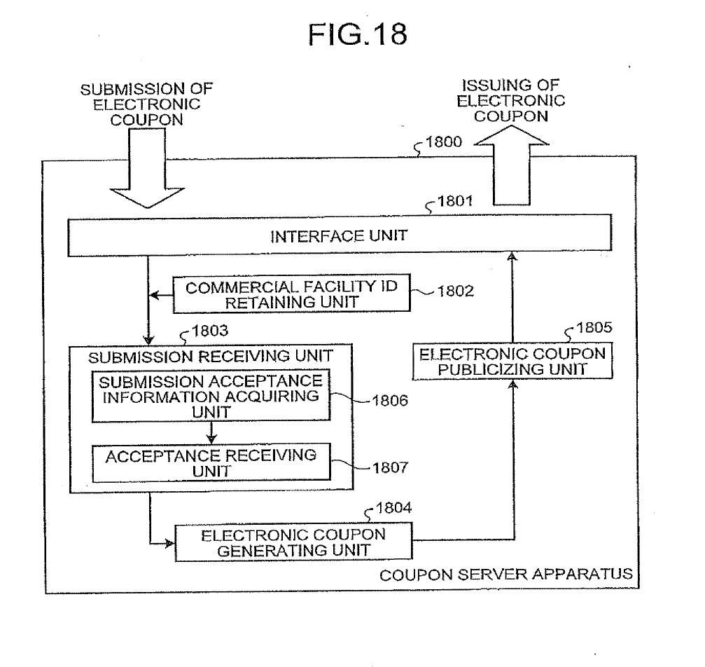

FIG. 18 is a diagram illustrating a functional block of a coupon server apparatus in the electronic coupon Management system according to this embodiment. As illustrated in the drawing, a “coupon server apparatus” 1800 according to this embodiment includes an “interface unit” 1801, a “commercial facility ID retaining unit” 1802, a “submission receiving unit” 1803, an “electronic coupon generating unit” 1804, and an “electronic coupon publicizing unit” 1805. The submission receiving unit includes a “submission acceptance information acquiring unit” 1806 and an “acceptance receiving unit” 1807. The basic configuration of the coupon server apparatus is the same as that of the coupon server apparatus described with reference to FIG. 4 in the first embodiment. Therefore, the “submission acceptance information acquiring unit” and the “acceptance receiving unit” which are different constituent elements will be described below.

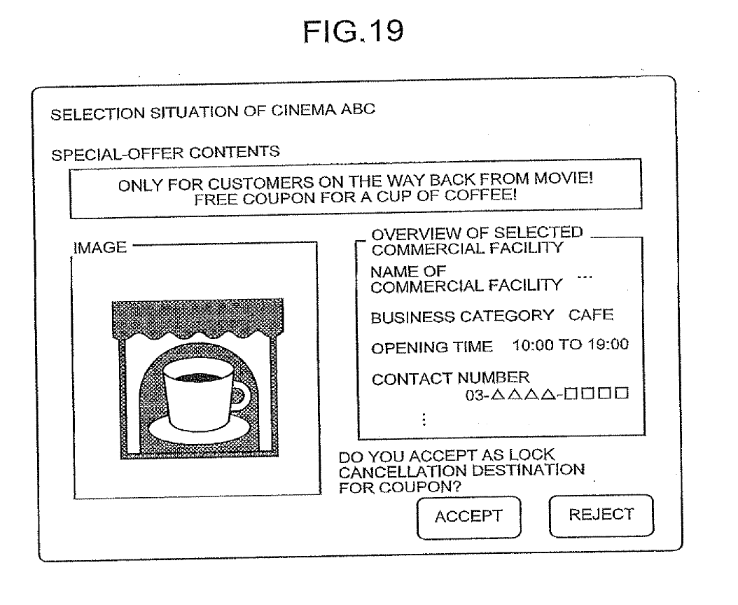

The “submission acceptance information acquiring unit” has a function of acquiring submission acceptance information which is information indicating submission acceptance of a commercial facility selected for the submission. The phrase, “information indicating the submission acceptance of the commercial facility selected for the submission” means information indicating that the commercial facility itself accepts serving as the lock cancellation destination of an electronic coupon or does not reject serving as the lock cancellation destination of an electronic coupon. As a specific method of acquiring the submission acceptance information, for example, a method can be considered in which information is transmitted to request a terminal apparatus in the commercial facility selected as the lock cancellation destination whether to accept the selection and a response to the information is received. Here, a coupon submission notification screen is illustrated in FIG. 19 as an example of a configuration in which whether to accept the submission is requested. FIG. 19 is a diagram illustrating the coupon submission notification screen which indicates the contents of an electronic coupon submitted designating commercial facility “Cinema ABC” as the lock cancellation destination. In the screen, a terminal apparatus in “Cinema ABC” accesses the coupon server apparatus and logs in the coupon management system.

On the coupon submission notification screen illustrated in FIG. 19, information to an electronic coupon is displayed. Further, an acceptance button pressed down to accept the issue of the electronic coupon is displayed and a rejection button pressed down to reject the issue of the electronic coupon is also displayed. By clicking the “acceptance” button, the submission acceptance information is transmitted to the coupon server apparatus. By clicking the “rejection” button, the coupon server apparatus is notified of information indicating rejection of the submission. The submission acceptance information acquiring unit acquires the submission acceptance information of an advertisement from a terminal apparatus in the commercial facility selected as the lock cancellation destination or the information indicating the rejection of the submission.

When the response to the information is not received even after a predetermined time, it may be determined that the submission is accepted and the submission acceptance information may be acquired. Conversely, it may be determined that the submission is not accepted. The determination whether to accept the submission is appropriately set.

When registration of block destination information, which is the commercial facility attribute used to reject the submission of the electronic coupon for which the own commercial facility is set as the lock cancellation destination, is received and stored in advance from each commercial facility and the block destination information of the commercial facility selected for the submission includes the attribute of the commercial facility which is the submission source, it may be confirmed that the submission acceptance information is not obtainable. As a specific commercial facility attribute considered as the contents of the block destination information, for example, a case can be considered in which the types of business or the forms of business are the same or similar or locations are remote from each other. Even when the commercial facility itself having the commercial facility attribute submits the electronic coupon as the lock cancellation destination, it is difficult to sufficiently obtain the advantage expected as the lock cancellation destination described above. Therefore, it is desirable to set intent that the selection of the lock cancellation destination is not accepted in advance.

The “acceptance receiving unit” has a function of receiving only the submission for which the submission acceptance information acquiring unit obtains the submission acceptance information. The phrase, “receiving only the submission for which the submission acceptance information is acquired” specifically means performing the process of writing a coupon key of only an electronic coupon for which the submission acceptance information is acquired by the submission acceptance information acquiring unit, when FIG. 2 is referred to for the description. Here, the submission of the electronic coupon confirmed that the submission acceptance information is not obtainable is not received. However, information indicating non-reception of the submission may be transmitted to a commercial facility submitting this electronic coupon. Specifically, for example, a method can be considered in which an electronic mail having the contents of a sentence indicating non-reception of the submission, such as “Unfortunately, the electronic coupon which your facility submits may not be issued.” is transmitted to the address of an electronic mail registered as the commercial facility ID. In the configuration, the commercial facility that does not receive the submission can prevent a newly searching timing of a commercial facility preferred as the lock cancellation destination from missing.

Specific Configuration of Coupon Server Apparatus

The hardware configuration of the coupon server apparatus according to this embodiment is basically the same as the hardware configuration of the coupon server apparatus described with reference to FIG. 9 in the first embodiment. Therefore, specific processes of the submission acceptance information acquiring unit and the submission receiving unit not described in the first embodiment will be described below.

Specific Process of Submission Acceptance Information Acquiring Unit

The CPU executes an “acceptance information acquiring program” to acquire information indicating acceptance of the submission from the selected commercial facility and stores the result in a predetermined address of the main memory.

Specific Process of Submission Receiving Unit

The CPU executes a “submission acceptance program” by reading the information obtained through the execution of the acceptance information acquiring program, performs the process of receiving the submission of the electronic coupon, and stores the result in a predetermined address of the main memory.

Flow of Process

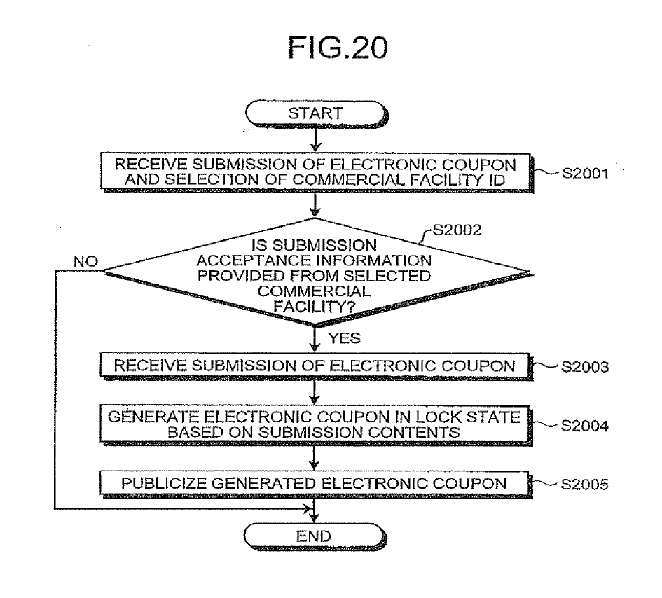

FIG. 20 is a diagram illustrating an example of the flow of a process performed by the coupon server apparatus according to this embodiment. The flow of the process illustrated in FIG. 20 includes the following steps. First, in step S2001, the selection of the commercial facility ID and the submission of the electronic coupon are received from an external terminal via the interface. Next, in step S2002, a process is performed to determine whether the submission acceptance information is provided from the selected commercial facility. When it is determined that the submission acceptance information is provided, the process proceeds to step S2003. Conversely, when it is determined that the submission acceptance information is not provided, the subsequent process is not performed. Next, in step S2003, the submission of the electronic coupon is received. Then, in step S2004, the electronic coupon is generated in the lock state. Next, in step S2005, the generated electronic coupon is publicized via the interface

Advantage

In the electronic coupon management system including the coupon server apparatus according to this embodiment, the commercial facility selected as the coupon submission destination can select the electronic coupon of which the lock is cancelled depending on the determination of the commercial facility itself, in addition to the advantage of the first embodiment. Therefore, the commercial facility can construct a corporation relation with the commercial facilities considered to be advantageous.

### Fifth Embodiment

### Overview

An electronic coupon management system according to this embodiment is basically the same as the electronic coupon management system according to the third embodiment. However, input of commercial facility attributes is received from an external terminal via the interface unit, a commercial facility ID associated with the input and received commercial facility attributes is acquired, and the list of the electronic coupons for which the commercial facility specified with the acquired commercial facility ID is publicized as a lock cancellation destination commercial facility is output to the external terminal via the interface unit. In the configuration according to this embodiment, the commercial facility can easily select the commercial facility very suitable for the demand of the commercial facility itself as the lock cancellation destination before the submission of the electronic coupon.

Functional Configuration

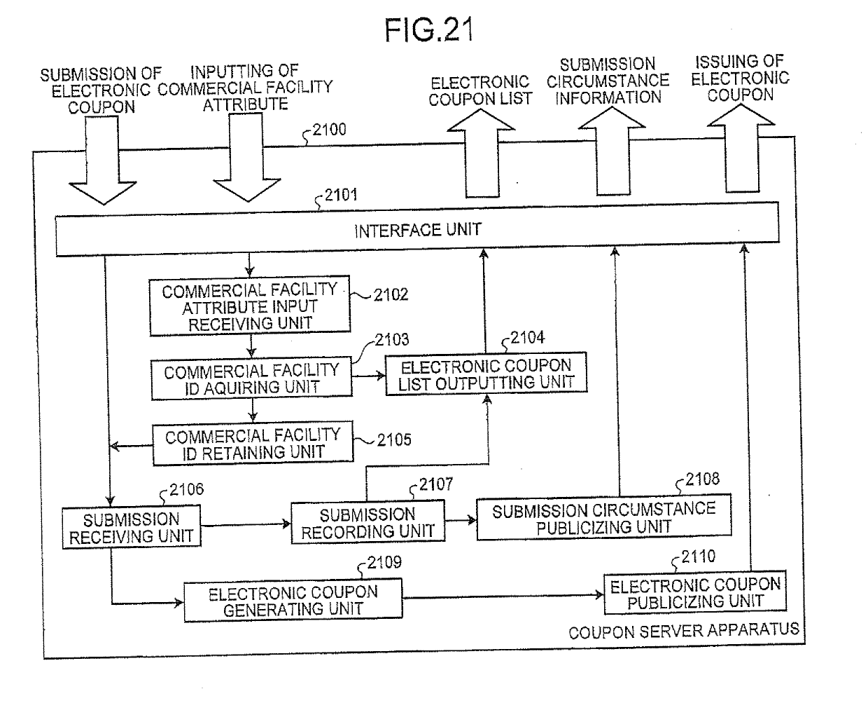

FIG. 21 is a diagram illustrating an example of the functional block of the coupon server apparatus in the electronic coupon management system according to this embodiment. As illustrated in the drawing, a “coupon server apparatus” 2100 according to this embodiment includes an “interface unit” 2101, a “commercial facility attribute input receiving unit” 2102, a “commercial facility ID acquiring unit” 2103, an “electronic coupon list outputting unit” 2104, a “commercial facility ID retaining unit” 2105, a “submission receiving unit” 2106, a “submission recording unit” 2107, a “submission circumstance publicizing unit” 2108, an “electronic coupon generating unit” 2109, and an “electronic coupon publicizing unit” 2110. The basic configuration of the coupon server apparatus is the same as that of the coupon server apparatus described with reference to FIG. 13 in the third embodiment. Therefore, the “commercial facility attribute input receiving unit,” the “commercial facility ID acquiring unit,” and the “electronic coupon list outputting unit” which are different constituent elements will be described below.

The “commercial facility attribute input receiving unit” has a function of receiving the input of the commercial facility attribute from an external terminal via the interface unit. The phrase, “receiving the input of the commercial facility attributes” specifically means that a user inputs specific commercial facility attributes to an external terminal and searches for the commercial facility having the commercial facility attributes. For example, when the user desires to set the commercial facility having the commercial facility attributes of “a karaoke bar,” “customers are a 50s female,” and “close time is between 20 o'clock to 21 o'clock” as the lock cancellation destination at the time of examining the submission of the electronic coupons, the user searches for the corresponding commercial facility by inputting the corresponding commercial facility attributes.

The “commercial facility ID acquiring unit” has a function of searching for and acquiring the commercial facility ID associated with the input and received commercial facility attributes from the commercial facility ID retaining unit. In addition, the input and received commercial facility attributes may not necessarily accord with the retained commercial facility attributes. That is, two commercial facility attributes may be “associated” with each other. For example, when the commercial facility attributes of a high-level concept are common, the commercial facility attributes are considerably preferably determined to be “associated” with each other. For example, when the input of a “sports gymnasium” is received, the commercial facility attribute of a “fitness facility” such as a “rented futsal court” or a “rented tennis court” in addition to the commercial facility having the commercial facility attribute of the “sports gymnasium” may be set as the high-level concept and the commercial facility ID having the commercial facility attribute may be acquired. In the configuration, the commercial facility attributes retained in the commercial facility ID retaining units may be configured in a plurality of layers.

The “electronic coupon list outputting unit” has a function of outputting, via the interface unit, a list of the electronic coupons for which the commercial facility specified with the commercial facility ID acquired by the commercial facility ID acquiring unit is publicized as the lock cancellation destination commercial facility. Here, in the contents of the list, information of the electronic coupon which is information other than the information specified with the commercial facility ID forms the contents of the list by reading the information of the electronic coupon corresponding to the commercial facility ID.

As a specific output method, for example, the names of all the specified commercial facilities may be listed in the Japanese alphabet order or a plurality of lists obtained by classifying the commercial facilities in detail in accordance with the types of business may be provided and appropriately displayed. In the configuration, a plurality of candidates of the commercial facilities which are the lock cancellation destination can be selected before the submission of the electronic coupons. Further, information to the number, the business category, or the like of other commercial facilities using the commercial facility as the lock cancellation destination can be easily understood. Therefore, it is possible to select the commercial facility considered to expect the very suitable customer attracting effect after examining the characteristics.

Specific Configuration of Coupon Server Apparatus

The hardware configuration of the coupon server apparatus according to this embodiment is basically the same as the hardware configuration of the coupon server apparatus described with reference to FIG. 9 in the third embodiment. Therefore, specific processes of the commercial facility attribute input receiving unit, the commercial facility ID acquiring unit, and the electronic coupon list outputting unit not described in the third embodiment will be described below.

Specific Process of Commercial Facility Attribute Input Receiving Unit

The CPU-executes a “commercial facility attribute input receiving program” to perform a process of receiving the input of any commercial facility attribute and storing the result in a predetermined address of the main memory.

Specific Process of Commercial Facility ID Acquiring Unit

The CPU executes a “commercial facility ID acquiring program” to perform a process of searching for information of the commercial facility attributes associated with the information obtained through the execution of the commercial facility attribute input receiving program in the database and stores the result in a predetermined address of the main memory.

Specific Process of Electronic Coupon List Outputting Unit

The CPU executes an “electronic coupon list outputting program”, performs a process of reading information obtained through the execution of the commercial facility ID acquiring program and listing the information, and performs a process of publicizing the result.

Flow of Process

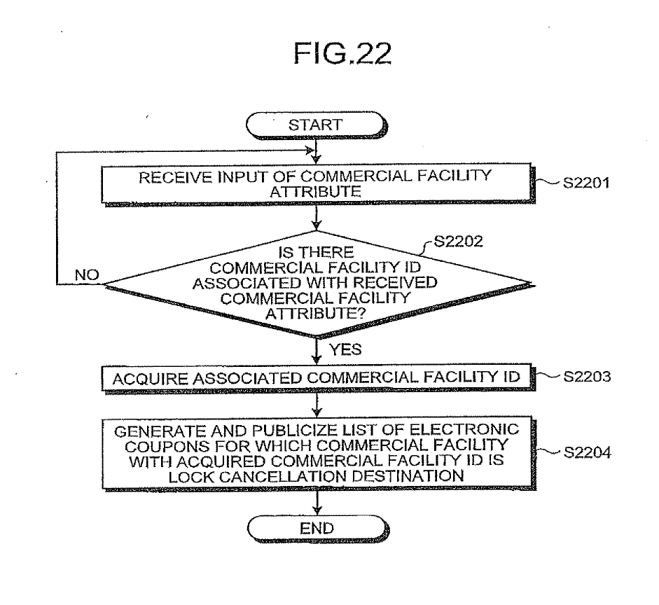

FIG. 22 is a diagram illustrating an example of the flow of a process performed by the coupon server apparatus according to this embodiment. The flow of the process illustrated in FIG. 22 includes the following steps. First, at step S2201, the input of the commercial facility attribute is received from an external terminal. Next, at step S2202, it is determined whether the commercial facility ID associated with the input and received commercial facility attribute is retained. Here, when it is determined that the commercial facility ID associated with the commercial facility attribute is retained, the process proceeds to step S2203. Conversely, when it is determined that the commercial facility ID associated with the commercial facility attribute is not retained, the process returns to step S2201. At step S2203, the commercial facility ID associated with the commercial facility attribute and information regarding the electronic coupon for which the commercial facility specified with the commercial facility ID is the lock cancellation destination are acquired. Next, at step S2204, the list of the electronic coupons having the commercial facility with the acquired commercial facility ID as the lock cancellation destination is output.

Advantage

In the electronic coupon management system including the coupon server apparatus according to this embodiment, the commercial facility can easily select the commercial facility very suitable for the demand of the commercial facility itself as the lock cancellation destination before the submission of the electronic coupon, in addition to the advantage of the third embodiment.

### Sixth Embodiment

### Overview

An electronic coupon management system according to this embodiment is basically the same as the electronic coupon management system according to the first embodiment. However, electronic coupon management system further includes a lock cancellation terminal apparatus that cancels the lock of the electronic coupon in a commercial facility selected as the lock cancellation destination. In the configuration according to this embodiment, it is possible to enable the electronic coupon of a customer who visits the selected commercial facility to be available and maintain an inducing environment in which the customer is induced to visit the commercial facility which is an electronic coupon submission destination.

Functional Configuration

The “electronic coupon system” according to this embodiment includes a “coupon server apparatus” and a “lock cancellation terminal apparatus,” The basic configuration of the coupon server apparatus is the same as the coupon server apparatus described with reference to FIG. 4 in the first embodiment. Therefore, the “lock cancellation terminal apparatus” which is a different constituent element will be described below.

The “lock cancellation terminal apparatus” has a function of cancelling the lock of the electronic coupon in the commercial facility selected as the lock cancellation destination. The phrase, “cancelling the lock of the electronic coupon” means that the electronic coupon is a state in which a customer can use the electronic coupon. As a specific method of cancelling the lock of the electronic coupon, as described above with reference to FIGS. 2 and 3, a method of writing information regarding a coupon key in the data of the electronic coupon can be considered to enable the electronic coupon to be available. As a method of writing the coupon key, a method can be considered in which information regarding the position of a portable terminal apparatus of a customer and information regarding the position of the lock cancellation terminal apparatus installed in the selected commercial facility are combined using a current position measuring system such as a GPS and the information regarding the coupon key is transmitted to the portable terminal apparatus of the customer. Alternatively, a method can be considered in which the portable terminal apparatus of the customer closely approaches the lock cancellation terminal apparatus installed in the commercial facility and the information regarding the coupon key is transmitted from the lock cancellation terminal apparatus to the portable terminal apparatus through near field communication. Further, a lock cancellation timing may be a timing at which the customer enters the commercial facility or may be a timing at which the customer purchase a product at the commercial facility or pays the fee of a provided service.

Specific Configuration of Lock Cancellation Terminal Apparatus

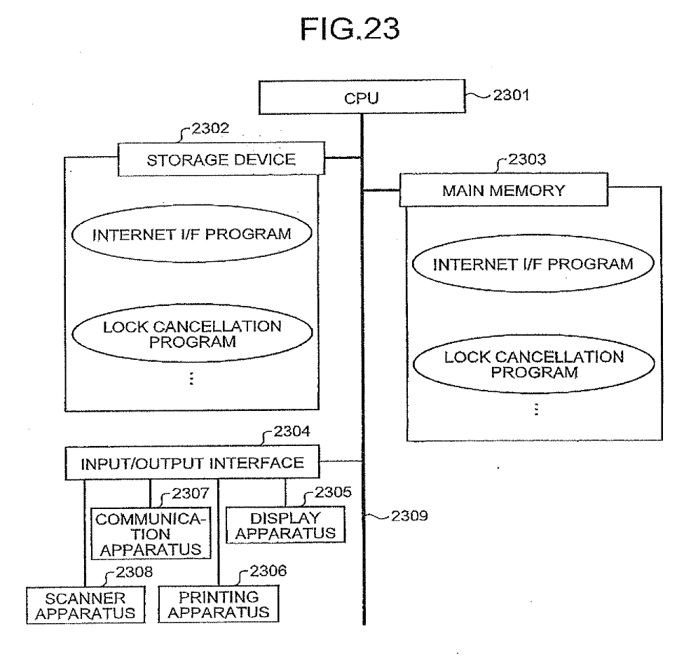

FIG. 23 is a schematic diagram illustrating an example of a hardware configuration when each functional constituent element of the lock cancellation terminal apparatus is realized by a computer. The function of each hardware constituent element will be described with reference to the drawing.

As illustrated in FIG. 23, the lock cancellation terminal apparatus includes a “CPU” 2301 that executes various arithmetic processes, a “storage device (storage medium)” 2302, a “main memory” 2303, an “input/output interface” 2304. The lock cancellation terminal apparatus transmits and receives information to and from, for example, a “display apparatus” 2305, a “printing apparatus” 2306, a “communication apparatus” 2307, a “scanner apparatus” 2308, and the like via the input/output interface. The CPU develops various kinds of programs retained in the storage device in the main memory and executes the programs. The above-described hardware constituent elements are connected to each other via a data communication path such as a “system bus” 2309 to perform processes of transmitting and receiving information.

Flow of Process

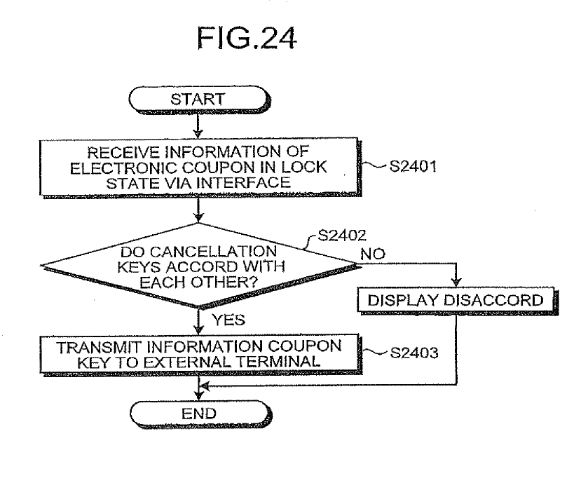

FIG. 24 is a diagram illustrating an example of the flow of a process performed by the lock cancellation terminal apparatus of the electronic coupon management system according to this embodiment. The flow of the process illustrated in FIG. 24 includes the following steps. First, at step S2401, information of an electronic coupon file in the lock state is received via the interface. Next, at step S2402, a process is performed to determine whether information of a cancellation key included in the electronic coupon file accords with information of a cancellation key retained in the lock cancellation terminal apparatus. When it is determined that the cancellation keys accord with each other, the process proceeds to step S2403. Conversely, when it is determined that the cancellation keys do not accord with each other, the fact that the cancellation keys do not accord with each other is displayed, and then the process ends. At step S2403, the information of the coupon key is transmitted to the external terminal via the interface.

Advantage

In the electronic coupon management system including the coupon cancellation terminal apparatus according to this embodiment, it is possible to maintain the inducing environment in which a customer is induced to visit the commercial facility which is the electronic coupon submission destination.

According to an aspect of an embodiment of the invention, an increase in the number of customers or the number of users can be expected by causing many users to recognize a commercial facility selected and designated as a lock cancellation destination of coupons as a facility at which a beneficial coupon can be accepted via a publicized web. In the specification, “users” refer to all other than an operator who uses the electronic coupon management system according to the invention. Specifically, “users” are a general term of commercial facilities which are a submission destination of an electronic coupon, commercial facilities which are a lock cancellation destination, and customers or the like receiving an electronic coupons.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic coupon management system comprising:
a coupon server apparatus including
an interface unit that is publicized to an external terminal apparatus via a network,
a commercial facility ID (Identification) retaining unit that retains commercial facility IDs,
a submission receiving unit that receives submission of an electronic coupon via the interface unit along with selection of at least one commercial facility ID from the commercial facility IDs retained in the commercial facility ID retaining unit,
an electronic coupon generating unit that generates the submission-received electronic coupon in a lock state which is cancellable by the selected commercial facility, and
an electronic coupon publicizing unit that publicizes the electronic coupon generated by the electronic coupon generating unit via the interface unit to make the electronic coupon available to a customer.

2. The electronic coupon management system according to claim 1, wherein the coupon server apparatus further includes
a commercial facility registration receiving unit that receives registration of a commercial facility to be specified with the commercial facility ID retained by the commercial facility ID retaining unit together with a commercial facility attribute which is an attribute of the commercial facility, and
a commercial facility ID recording unit that records the commercial facility ID of the commercial facility registered and received by the commercial facility registration receiving unit in association with the commercial facility attribute in the commercial facility ID retaining unit, and
the submission receiving unit includes a commercial facility attribute using unit that causes the recorded commercial facility attribute to be available via the interface unit for the selection of the commercial facility ID.

3. The electronic coupon management system according to claim 1, wherein the coupon server apparatus further includes
a submission recording unit that records information regarding the received submission in a database, and
a submission circumstance publicizing unit that publicizes the information regarding the submission recorded in the database via the interface unit.

4. The electronic coupon management system according to claim 1, wherein the submission receiving unit includes
a submission acceptance information acquiring unit that acquires submission acceptance information which is information indicating submission acceptance of the commercial facility selected at the submission via the interface unit, and
an acceptance receiving unit that receives the submission for which the submission acceptance information is obtained by the submission acceptance information acquiring unit.

5. The electronic coupon management system according to claim 2, wherein the coupon server apparatus further includes
a commercial facility attribute input receiving unit that receives an input of the commercial facility attribute via the interface unit,
a commercial facility ID acquiring unit that acquires the commercial facility ID associated with the input and received commercial facility attribute, and
an electronic coupon list outputting unit that outputs a list of the electronic coupon for which the commercial facility specified with the acquired commercial facility ID is publicized as a lock cancellation destination.

6. The electronic coupon management system according to claim 1, further comprising:
a lock cancellation terminal apparatus that cancels the lock state of the electronic coupon in the commercial facility.

7. An electronic coupon management method comprising:
receiving, by a computer, submission of an electronic coupon along with selection of a commercial facility ID (Identification);
generating, by the computer, the submission-received electronic coupon in a lock state which is cancellable by the selected commercial facility; and
publicizing, by the computer, the generated electronic coupon via an interface unit which is publicized to an external terminal apparatus to make the electronic coupon available to a customer.

8. A non-transitory computer readable storage medium containing program instructions for managing an electronic coupon, wherein execution of the program instructions by one or more processors of a computer system causes the one or more processors to perform:
receiving submission of an electronic coupon along with selection of a commercial facility ID (Identification);
generating the submission-received electronic coupon in a lock state which is cancellable by the selected commercial facility; and
publicizing the generated electronic coupon via an interface unit which is publicized to an external terminal apparatus to make the electronic coupon available to a customer.
